(19) United States
(12) Patent Application Publication
(10) Pub. No.: US 2024/0371109 A1
(43) Pub. Date: Nov. 7, 2024

(54) Dynamic Host Renderer For Artificial Reality Systems

(71) Applicant: Meta Platforms Technologies, LLC, Menlo Park, CA (US)

(72) Inventors: Walter J. LUH, Sunnyvale, CA (US); Cameron SYLVIA, Dana Point, CA (US); Alexey MEDVEDEV, Fairfield, CA (US); Eric GRIFFITH, Houston, TX (US)

(21) Appl. No.: 18/311,915

(22) Filed: May 4, 2023

(51) Int. Cl. G06T 19/00; G06F 9/54

(52) U.S. Cl. CPC G06T 19/006; G06F 9/546

(57) ABSTRACT

Aspects of the present disclosure are directed to a host renderer for artificial reality system(s) that provides dynamic rendering for application(s). Implementation of the host renderer decouple rendering of content from content source(s) to improve compatibility, extensibility, processing efficiency, and other aspects of content rendering. An artificial reality application can generate a scene graph with scene components, or renderable/drawable elements of the scene graph. The host renderer is configured to receive an encoded version of the artificial reality application's scene graph and issue processor rendering calls to render the drawable/renderable components of the scene graph. The host renderer abstracts the hardware level rendering calls and provides the artificial reality application access to hardware rendering via the host renderer. Implementations of the host renderer can perform rendering optimizations and issue a diverse set of processor rendering calls to diverse hardware.

### CROSS-REFERENCE TO RELATED APPLICATIONS

This application is related to U.S. patent application Ser. No. xx/xxx,xxx, having Attorney Docket No. 3589-0244US01, titled “Dynamic Host Renderer for Artificial Reality Systems;” and to U.S. patent application Ser. No. xx/xxx,xxx, having Attorney Docket No. 3589-0244US02, titled “Dynamic Host Renderer for Artificial Reality Systems;” and to U.S. patent application Ser. No. xx/xxx,xxx, having Attorney Docket No. 3589-0244US04, titled “Dynamic Host Renderer for Artificial Reality Systems;” each filed on May 4, 2023, and each is herein incorporated by reference in its entirety.

### TECHNICAL FIELD

The present disclosure is directed to a host renderer for artificial reality system(s) that provides dynamic rendering for application(s).

### BACKGROUND

Artificial reality (XR) devices are becoming more prevalent. As they become more popular, the applications implemented on such devices are becoming more sophisticated. Augmented reality (AR) applications can provide interactive 3D experiences that combine images of the real-world with virtual objects, while virtual reality (VR) applications can provide an entirely self-contained 3D computer environment. For example, an AR application can be used to superimpose virtual objects over a video feed of a real scene that is observed by a camera. A real-world user in the scene can then make gestures captured by the camera that can provide interactivity between the real-world user and the virtual objects. Mixed reality (MR) systems can allow light to enter a user's eye that is partially generated by a computing system and partially includes light reflected off objects in the real-world. AR, MR, and VR experiences can be observed by a user through a head-mounted display (HMD), such as glasses or a headset.

XR experiences can include an XR scene with multiple scene components, such as a sky box, background, virtual objects, lighting, and the like. Rendering such an XR scene involves a complex set of rendering and/or compute tasks, such as generating and executing a rendering pipeline via call(s) to one or more hardware processers. In addition, a variety of hardware processor types, rendering techniques, and other suitable rendering variations present compatibility and inter-operability challenges for XR scene content sources, such as XR applications.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a conceptual diagram of content flow from a content source to computer processor(s) via a host renderer.

FIG. 6 is a system diagram comprising a host renderer that performs dynamic rendering for content source(s).

FIG. 7A is a conceptual diagram for encoding and rendering a scene graph using a hardware interface.

FIG. 7B is a conceptual diagram for generating rendering information using encoded scene component(s).

FIG. 8 is a system diagram comprising a host renderer that performs dynamic rendering for content source(s) via a variety of rendering types and processor types.

FIG. 9A is a system diagram comprising a host renderer that performs joint dynamic rendering using content from multiple sources.

FIG. 9B is a system diagram comprising a host renderer that performs joint dynamic rendering of multiple scene graphs using inter-process communication to maintain scene graph(s) state.

FIGS. 10A, 10B, 10C, and 10D are system diagrams comprising a host bridge that converts an external component for rendering by a rendering engine.

FIG. 11 is a conceptual diagram of elements that comprise a host renderer.

FIG. 12 is a flow diagram illustrating processes used in some implementations for dynamically rendering scene components from an encoded XR scene graph using a host renderer.

FIG. 13 is a flow diagram illustrating processes used in some implementations for issuing software calls to multiple processor types using a host renderer to render encoded XR scene graph(s).

FIG. 14 is a flow diagram illustrating processes used in some implementations for dynamically rendering scene components from multiple encoded XR scene graphs using a host renderer.

FIG. 15 is a flow diagram illustrating processes used in some implementations for dynamically rendering scene components from multiple artificial reality (XR) applications using a host bridge.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to a host renderer for artificial reality system(s) that provides dynamic rendering for application(s). Implementations of the host renderer decouple rendering of content from content source(s) to improve compatibility, extensibility, processing efficiency, and other aspects of content rendering. For example, an artificial reality application can generate a scene graph with scene components, or renderable/drawable elements of the scene graph. The host renderer is configured to receive an encoded version of the artificial reality application's scene graph and issue processor rendering calls to render the drawable/renderable components of the scene graph. The host renderer abstracts the hardware level rendering calls (e.g., processor application programming interface (API) calls) and provides the artificial reality application access to hardware rendering via the host renderer. Implementations of the host renderer can perform rendering optimizations and issue a diverse set of processor rendering calls to diverse hardware.

A scene graph of an artificial reality application can represent scene components within an artificial reality scene. Example scene components include a sky box, background, virtual objects, and the like. The scene graph can include information for the scene components, such as their locations within the scene. The virtual objects in a scene graph can comprise relationships with one another and relationships to real-world objects. For example, a scene graph can be a hierarchy, document object model, or any other suitable structure of scene components. In some implementations, the artificial reality application performs physics simulations (e.g., motion simulation) for the artificial reality scene, and the application can accomplish this function using the relationships comprised in the scene graph.

The host renderer can be configured to receive scene graphs in an encoded format. For example, an encoder can encode the artificial reality application's scene graph and generate encoded scene components, or entities. The encoded scene components can comprise and/or indicate model data about the represented scene component, such as structure(s) (e.g., mesh, sub-models, etc.), material(s), texture(s), buffer(s), shader(s), etc. The encoded scene graph can also include metadata about rendering the encoded scene components. The host renderer can include a decoder that decodes the encoded scene graph and populates host primitives using the decoded information. For example, the host primitives can store rendering information used to generate processor rendering calls for each scene component, such as the structure information and/or material information.

Once the decoder decodes the encoded scene graph into host primitives, the host renderer can issue rendering call(s) (e.g., draw calls, rendering passes, etc.) to one or more processor(s) via a hardware interface. The hardware interface can comprise software component(s) that abstract hardware layer rendering calls via API(s). The host controller can generate the structure of the rendering calls using the hardware interface and issue the rendering calls to the one or more processors. In some implementations, the processor(s) can be any suitable processors for executing rendering calls/rendering pipeline(s), such as central processing units (CPUs), graphics processing units (GPUs), mobile processors, multi-core processors, any combination thereof, or any other suitable processors.

The rendering calls can cause the one or more processors to define pixel values that render the scene graph components. For example, the rendering calls can be a rendering pipeline that, when executed by the processor(s), draws the scene components represented in the encoded scene graph. In some implementations, the rendering calls issued from the host renderer can vary in type, and can include forward rendering, deferred rending, ray tracing, and any other suitable rendering types.

In some implementations, the host renderer can receive encoded scene graphs from multiple XR applications and issue processor rendering calls that jointly render the scene components from these scene graphs. For example, first and second applications can transmit their encoded scene graphs and updates for their encoded scene graphs to the host renderer. In some implementations, the first and second applications each execute in separate software processes, and thus the encoded scene graphs are received at the host renderer via inter-process communication messages.

In some implementations, the host renderer executes at a first device and at least a portion of the render draw calls are issued to a second device. For example, the first and second devices can comprise an artificial reality system. In some implementations, the first device can be a companion processing component of the artificial reality system, and the second device can be a head-mounted display of the artificial reality system. The one or more processors can comprise one or more mobile processors of the second device that execute the portion of the render draw calls.

In some implementations, the one or more processors execute the rendering pipeline and render a three-dimensional artificial reality scene comprising the rendered scene components. For example, the three-dimensional artificial reality scene can be displayed to the user via a head-mounted display of an artificial reality system as two displays (one for each eye) such that the displays immerse the user in the three-dimensional artificial reality scene.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

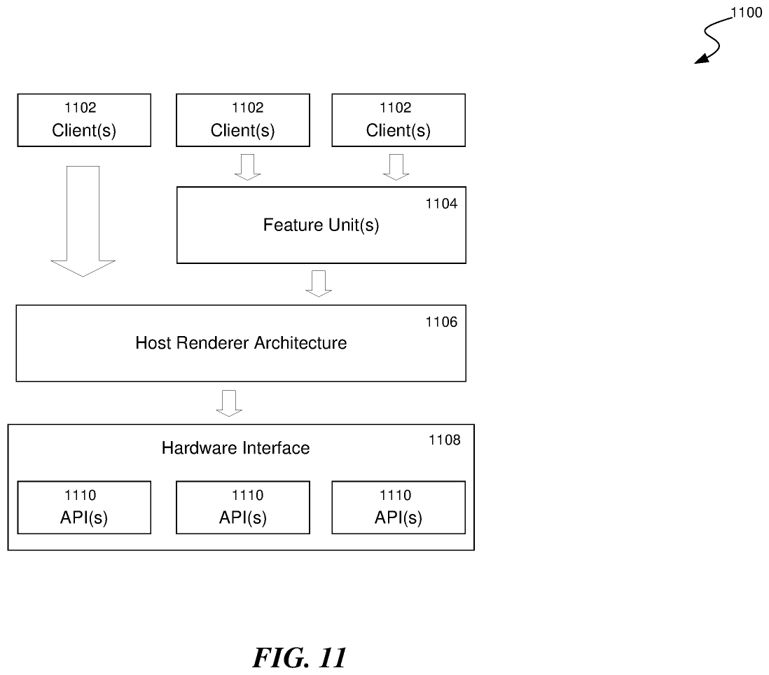

Implementation of the host renderer decouple rendering of content from content source(s) to improve compatibility, extensibility, processing efficiency, and other aspects of content rendering. FIG. 11 further describes elements that comprise a host renderer and the technical and operation improvements achieved by disclosed implementations.

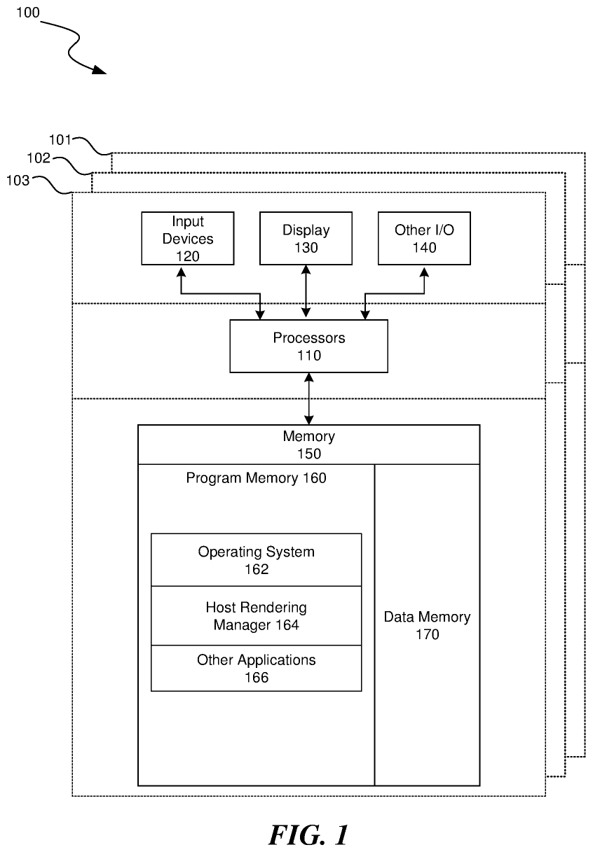

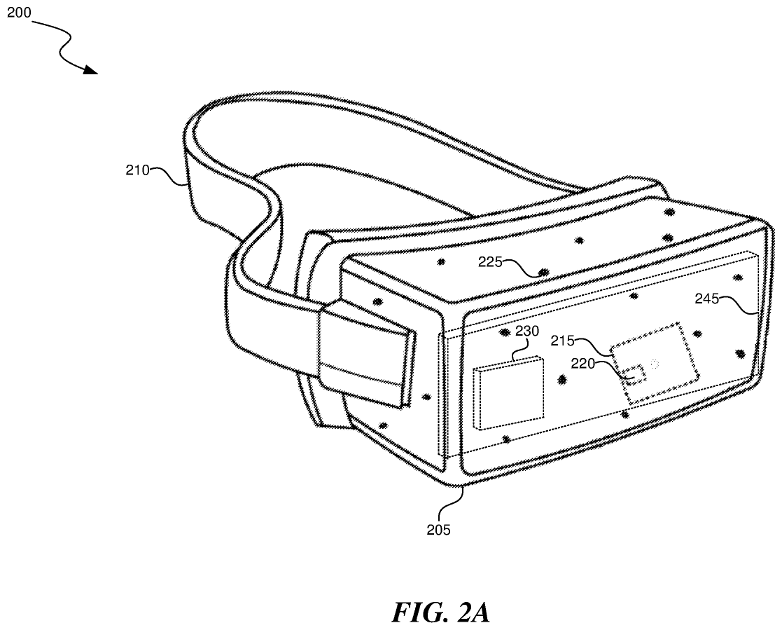

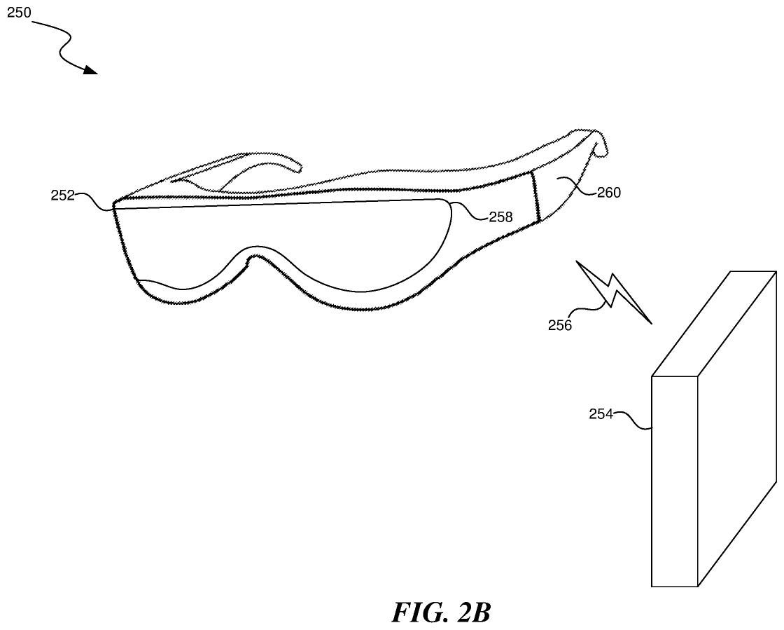

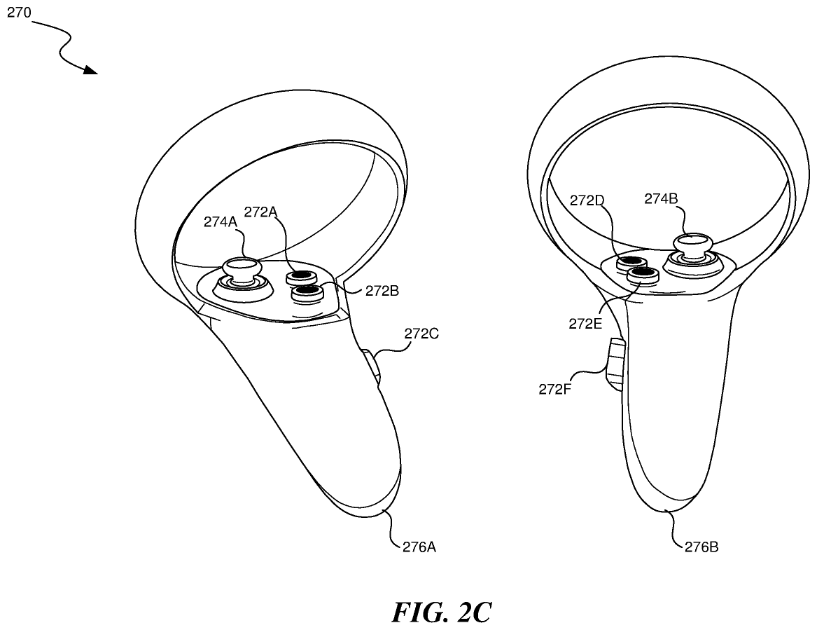

Several implementations are discussed below in more detail in reference to the figures. FIG. 1 is a block diagram illustrating an overview of devices on which some implementations of the disclosed technology can operate. The devices can comprise hardware components of a computing system 100 that dynamically render scene components from an encoded artificial reality (XR) scene graph using a host renderer. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, girds, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, host rendering manager 164, and other application programs 166. Memory 150 can also include data memory 170 that can include, e.g., scene graph(s) and scene component(s), encoded scene graph(s) and scene component(s), material information (e.g., textures), structural information (e.g., meshes), rendering metadata, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. The HMD 200 includes a front rigid body 205 and a band 210. The front rigid body 205 includes one or more electronic display elements of an electronic display 245, an inertial motion unit (IMU) 215, one or more position sensors 220, locators 225, and one or more compute units 230. The position sensors 220, the IMU 215, and compute units 230 may be internal to the HMD 200 and may not be visible to the user. In various implementations, the IMU 215, position sensors 220, and locators 225 can track movement and location of the HMD 200 in the real world and in an artificial reality environment in three degrees of freedom (3 DoF) or six degrees of freedom (6 DoF). For example, the locators 225 can emit infrared light beams which create light points on real objects around the HMD 200. As another example, the IMU 215 can include e.g., one or more accelerometers, gyroscopes, magnetometers, other non-camera-based position, force, or orientation sensors, or combinations thereof. One or more cameras (not shown) integrated with the HMD 200 can detect the light points. Compute units 230 in the HMD 200 can use the detected light points to extrapolate position and movement of the HMD 200 as well as to identify the shape and position of the real objects surrounding the HMD 200.

The electronic display 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3 DoF or 6 DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3 DoF or 6 DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

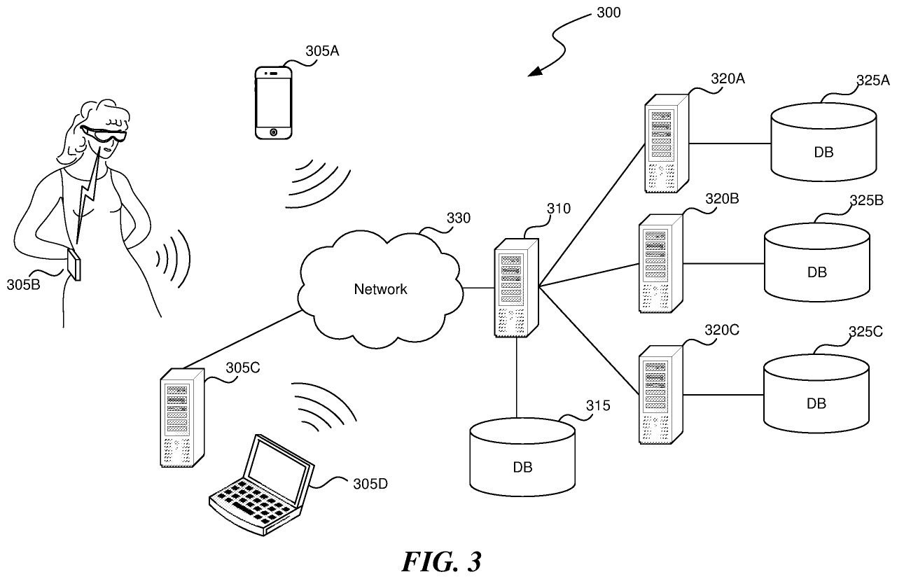

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

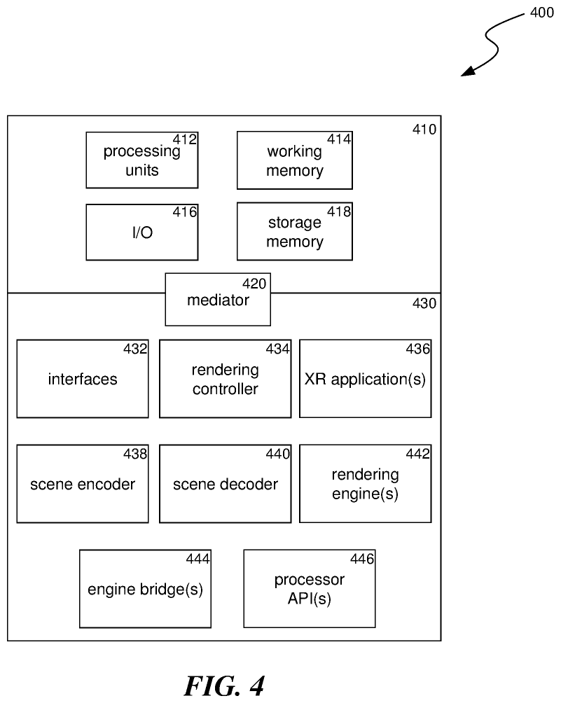

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for dynamically rendering scene components from an encoded artificial reality (XR) scene graph using a host renderer. Specialized components 430 can include rendering controller 434, XR application(s) 436, scene encoder 438, scene decoder 440, rendering engine(s) 442, engine bridge(s) 444, and processor API(s) 446, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

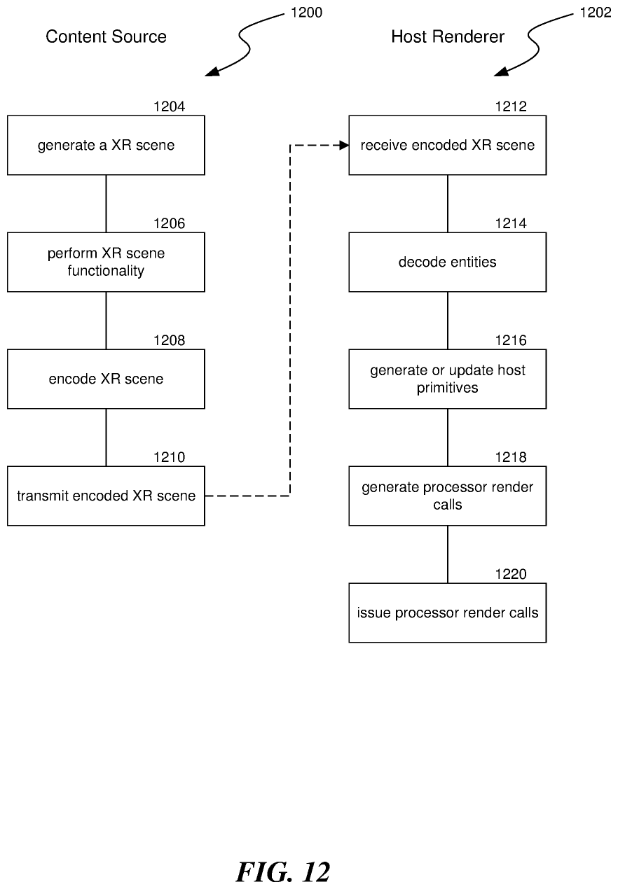

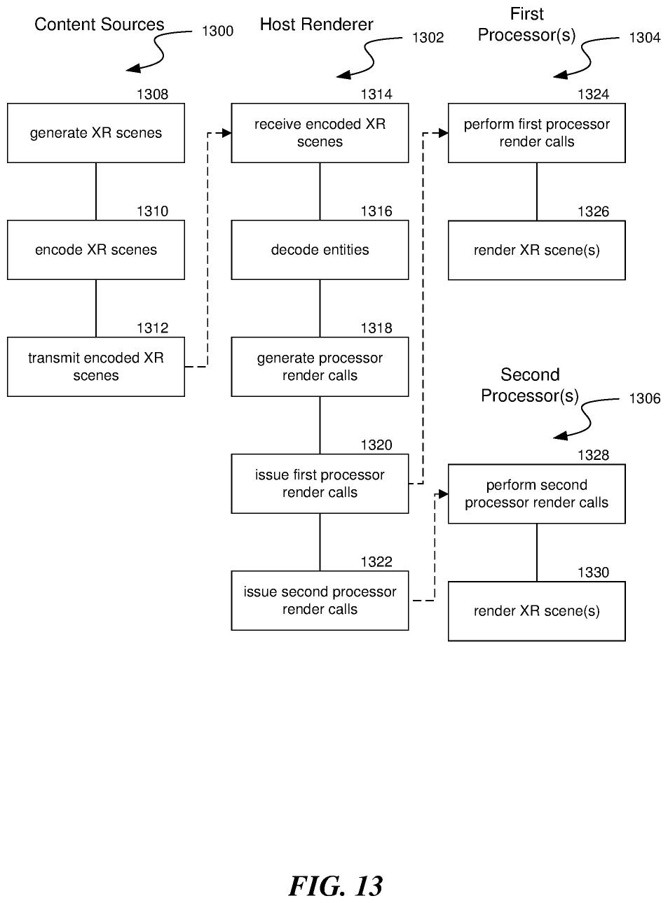

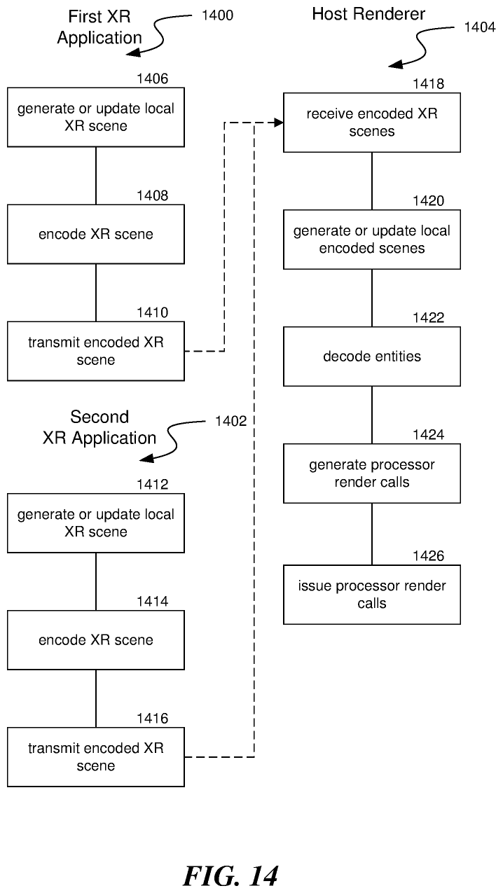

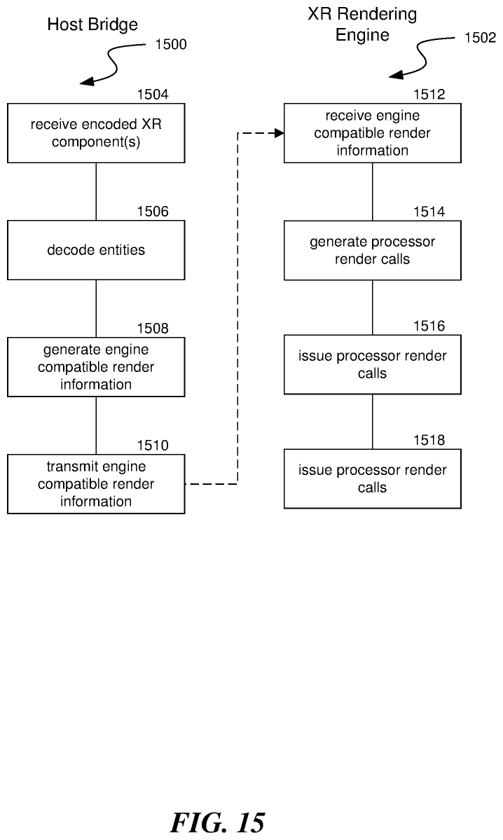

Rendering controller 434 can perform dynamic rendering for XR application(s) 436 and other sources of scene components. For example, rendering controller 434 can be part of a host renderer that receives encoded data for rendering (e.g., an encoded scene graph) and issues processor API(s) 446 calls to render the content. Rendering controller 434 can segregate rendering from other aspects of functionality of XR application(s) 436 (e.g., object interactions, physics, input processing, etc.). For example, rendering controller 434 can perform dynamic rendering for multiple content sources. Further details regarding rendering controller 434 are described with respect to blocks 1212-1220 of FIG. 12, blocks 1314-1322 of FIG. 13, blocks 1418-1426 of FIG. 14, and blocks 1516-1524 of FIG. 15.

XR application(s) 436 are application(s) that execute at XR systems (or other devices) and generate content for rendering, such as scene components of a scene graph. Scene components can include background(s), skybox(es), image(s), virtual object(s), avatar(s), and any other suitable components of a XR scene that comprises drawable/renderable content. In some implementations, XR application(s) 436 can be the source(s) of content (e.g., encoded scene graphs) for rendering by rendering controller 434. Rendering controller 434 and/or the host renderer can segregate rendering functionality from the other application functionality performed by XR application(s) 436, such as input processing, game simulation (e.g., physics operation, etc.), interactions among scene components, and other suitable functionality. Example XR application(s) 436 include XR gaming applications, XR applications that display shared XR environments, XR calling applications, or any other suitable XR application that displays a XR environment comprising an XR scene to a user. Further details regarding XR application(s) 436 are described with respect to blocks 1204-1210 of FIG. 12, blocks 1308-1312 of FIG. 13, blocks 1406-1416 of FIG. 14, and blocks 1508-1514 of FIG. 15.

Scene encoder 438 can encode content from XR application(s) 436, or other content sources, into an encoded format. For example, rendering controller 434 and/or the host renderer can support dynamic rendering for content received in the encoded format. In some implementations, scene encoder 438 encodes a scene graph from one of XR application(s) 436. The encoded scene graph can include encoded entities that represent the scene components of the scene graph and metadata for rendering the scene components as part of the scene graph. The encoded entities can store and/or indicate model data (e.g., three-dimensional meshes, buffers, etc.) and material data (e.g., materials, textures, shaders, etc.). The metadata for rendering the scene components can include metadata for performing render calls to one or more processors. In some implementations, the host renderer can persist instances of model data and/or instances of material data, and the encoded entities can comprise identifiers to these persisted instances.

In some implementations, scene encoder 438 can be a software development toolkit (SDK), plugin, or other suitable component of the host renderer that executes in combination with XR application(s) 436 (or other suitable sources of content for rendering). In some implementations, scene encoder can be part of XR application(s) 436 and/or the other suitable sources of content. Further details regarding scene encoder 438 are described with respect to block 1208 of FIG. 12, block 1310 of FIG. 13, blocks 1408 and 1414 of FIG. 14, and block 1512 of FIG. 15.

Scene decoder 440 can be a part of the host renderer that decodes encoded content, such as an encoded scene graph, received from content sources, such as XR application(s) 436. For example, scene decoder 440 can decode the encoded entities of a scene graph and convert these entities to host primitive structures. The host primitive structures can contain the information for rendering the scene components represented by the encoded entities, such as structure information (e.g., three-dimensional meshes), material information (e.g., material(s), texture(s), buffer(s), shader(s), etc.), and the like. In some implementations, scene decoder 440 can access persisted instances of mesh data and/or material data (stored by the host renderer) to generate the host primitive structures, such as specific instances identified by the encoded entities. Further details regarding scene decoder 440 are described with respect to block 1214 of FIG. 12, block 1316 of FIG. 13, block 1422 of FIG. 14, and block 1518 of FIG. 15.

Rendering engine(s) 442 can comprise engine(s) external to the host renderer that can generate hardware level software calls (e.g., via processor API(s) 446) for rendering content, such as components of a scene graph. In some implementations, rendering engine(s) 442 can comprise engine specific component primitives. For example, scene graph components can be represented as engine specific component primitives. A given one of rendering engine(s) 442 can execute an engine specific rendering pipeline to render the engine specific component primitives. In this example, the given one of rendering engine(s) 442 can render a scene graph using engine specific component primitives that represent the scene components of the scene graph.

In some implementations, one or more XR application(s) 436 can be compatible with one or more rendering engine(s) 442. For example, a given one of XR application(s) 436 can represent scene components of a scene graph using the engine specific component primitives that correspond to the given one of rendering engine(s) 442. Because the underlying scene component primitives are compatible, the given one of XR application(s) 436 can perform XR application functionality on the scene components and the given one of rendering engine(s) 442 can also render the scene components. Example rendering engines include one or more Unity or Unreal rendering engine(s), one or more horizon rendering engine(s), any rendering engine compatible with any of XR application(s) 436, and any other suitable rendering engine. Further details regarding processor rendering engine(s) 442 are described with respect to blocks 1526-1532 of FIG. 15.

Engine bridge(s) 444 can support interactions between the host renderer and rendering engine(s) 442. For example, the host renderer may comprise information for rendering one or more scene components, and the information may be stored as host primitive(s). One or more engine bridge(s) 444 can convert such host primitives to a format compatible with a given one of rendering engines 442. For example, the one or more engine bridge(s) 444 can convert the host primitives, and once converted, the host renderer can provide the converted primitives to the given one of rendering engine(s) 442. In this example, the given one of rendering engine(s) 442 can perform a rendering pipeline using the converted primitives to render the scene components. Further details regarding engine bridge(s) 444 are described with respect to blocks 1516-1524 of FIG. 15.

Processor API(s) 446 can expose hardware level functions to the host renderer and/or rendering engine(s) 442. For example, software calls via processor API(s) 446 can cause computer processor(s) to write pixel level data to render XR scenes comprising multiple scene components. Examples of processor API(s) 446 include OpenGL, Metal, Vulkan, and other suitable API(s) that can expose processor level software calls (e.g., hardware calls to central processing units (CPUs), graphical processing units (GPUs), mobile processors, etc.) to the host renderer and/or rendering engine(s) 442. Further details regarding processor API(s) 446 are described with respect to blocks 1218-1220 of FIG. 12, blocks 1320-1330 of FIG. 13, blocks 1424-1426 of FIG. 14, and blocks 1530-1532 of FIG. 15.

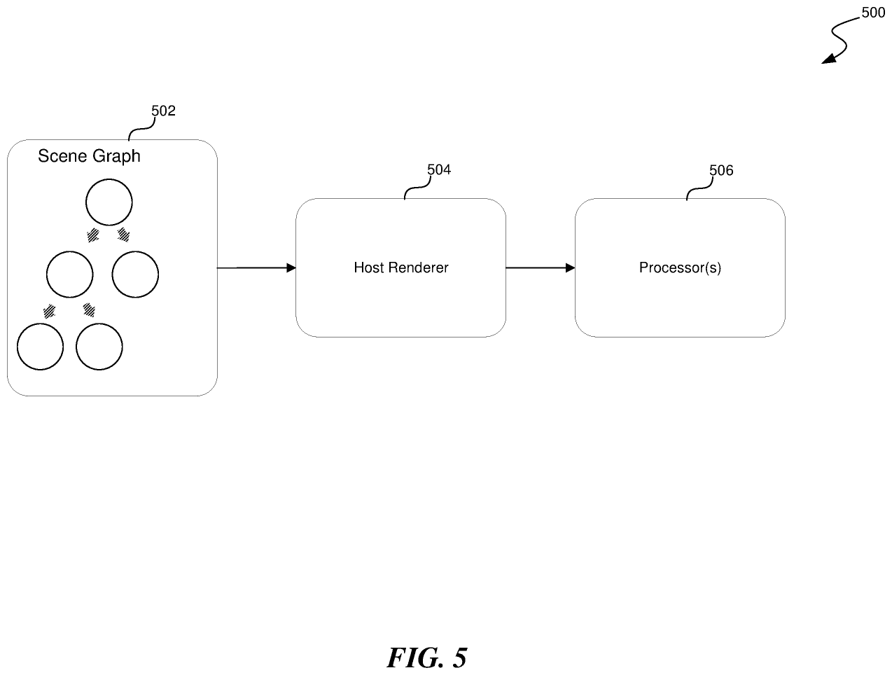

Implementations of the host renderer decouple rendering of content from content source(s) to improve compatibility, extensibility, processing efficiency, and other aspects of content rendering. FIG. 5 is a conceptual diagram of content flow from a content source to computer processor(s) via a host renderer. Diagram 500 includes scene graph 502, host renderer 504, and processor(s) 506. Host renderer 504 receives scene graph 502 from a given content source. Scene graph 502 can include scene components organized according to a given structure (e.g., hierarchy, document object model (DOM), etc.).

For example, scene graph 502 can represent scene components within an XR scene. Example scene components include a sky box, background, virtual objects, avatars, etc. Scene graph 502 can include information relative to the scene components, such as their locations within an XR scene. The virtual objects in scene graph 502 can comprise relationships with one another and/or with real-world objects. For example, a vehicle virtual object, such as a motorcycle, can include a passenger virtual object, such as an avatar and specify a position in an environment, e.g., relative to a defined anchor point. The passenger and motorcycle objects comprise a relationship that impacts the dynamics of these scene components. For example, the passenger's movement within the XR scene is based on the motorcycle's movement. Scene graph 502 can relate the passenger object to the motorcycle object to represent with scene component dependency. For example, the passenger object can be a child node to the motorcycle object in scene graph 502. Scene graph 502 can represent this dependency in any other suitable manner. In some implementations, an XR application performs physics simulations (e.g., motion simulation) for the XR scene, and the XR application can accomplish this function using the relationship between the motorcycle object and the passenger object represented in scene graph 502. Virtual objects in scene graph 502 can comprise other suitable dependencies and/or relationships.

In some implementations, host renderer 504 receives scene graph 502 (e.g., an encoded version of the scene graph) for the content source as part of a workflow to render the represented XR scene. For example, host renderer 504 can, in response to receiving scene graph 502, perform call(s) to processor(s) 506 to render the components of scene graph 502. Processor(s) 506 can perform rendering actions, based on the call(s), that ultimately define pixels values that render the components of scene graph 502. In this example, host renderer 504 is responsible for rendering content generated from a variety of other content sources.

Processor(s) 506 can represent a variety of processor types. For example, host renderer 504 can comprise a hardware interface that supports: a diverse set of rendering calls; and rendering calls to a diverse set of processor types. Host renderer 504 can therefore render content from a variety of different content sources via a variety of different types of rendering calls to a variety of different types of processor(s) 506.

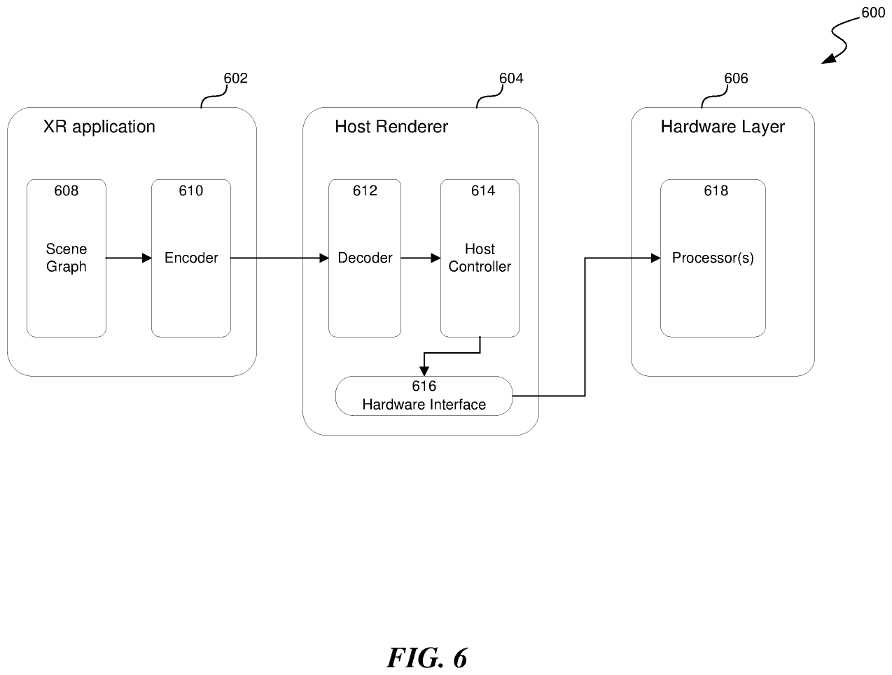

FIG. 6 is a system diagram comprising a host renderer that performs dynamic rendering for content source(s). Diagram 600 includes XR application 602, host renderer 604, hardware layer 606, scene graph 608, encoder 610, decoder 612, host controller 614, hardware interface 616, and processor(s) 618.

XR application 602 can represent a content source that provides content to host renderer 604 for dynamic rendering via render call(s) to hardware layer 606. XR application 602 can generate scene graph 608, such as a representation of an XR scene similar to scene graph 502 of FIG. 5. Prior to providing host renderer 604 with the scene components of scene graph 608, the scene graph is encoded via encoder 610. Encoder 610 can generate encoded scene components, or entities, from scene graph 608. XR application 602 and/or encoder 610 can provide the encoded scene graph to host renderer 604 and decoder 612. For example, decoder 612 can decode each entity of the encoded scene graph to generate/update host primitives used by host renderer 604 to render the scene components of scene graph 608.

The encoding of scene graph 608 can provide a source-neutral format for the scene graph. For example, a variety of different content sources can encode scene graph(s) via encoder 610 (or a similar encoder) prior to providing the scene graph(s) to host renderer 604. Such an architecture enables host renderer 604 to provide dynamic rendering services for a wide variety of XR application(s) and/or content sources. As long as a given content source encodes the content (e.g., scene graph) into host renderer 604's encoding format, host renderer 604 can support dynamic rendering for the given content source. For example, decoder 612 at host renderer 604 can decode entities (e.g., encoded scene components) for dynamic rendering from a variety of different content sources.

Once decoder 612 decodes the encoded scene graph into host primitives that store the entity information for rendering the scene components of scene graph 608, host controller 614 can issue rendering call(s) (e.g., draw calls) to hardware layer 606 and processor(s) 618 via hardware interface 616. For example, hardware interface 616 can comprise software component(s) that abstracts hardware layer rendering calls via API(s). Host controller 614 can generate the structure of the rendering calls using hardware interface 616 and issue the rendering calls to processor(s) 618 at hardware layer 606.

In some implementations, processor(s) 618 can be any suitable processors for executing rendering calls/rendering pipeline(s), such as central processing units (CPUs), graphics processing units (GPUs), mobile processors, multi-core processors, any combination thereof, or any other suitable processors. For example, a rendering pipeline can comprise compute functions and graphics functions, and hardware layer 606 can be configured to execute both the compute functions and graphics functions using one or more of processor(s) 618.

In some implementations, hardware layer 606 can comprise multiple devices. For example, a first device can comprise first processor(s) 618 and a second device can comprise second processor(s) 618. In this example, the first and second devices can be part of a XR system comprising multiple devices that each include separate processor hardware. For example, processor compute load for generating and displaying an XR scene (e.g., immersing a user in an XR environment) can be performed at both the first device and the second device. In some implementations, XR application 602 and/or host renderer 604 can execute at the first device, and at least a portion of rendering calls can be issued by host renderer 604 via hardware interface 616 to the second device. In this example, processor(s) 618 located at the second device can execute the portion of the rendering calls to render at least a portion of the XR scene represented by scene graph 608. In some implementations, the devices of the XR system can comprise a display device, such as an HMD, and a companion processing device.

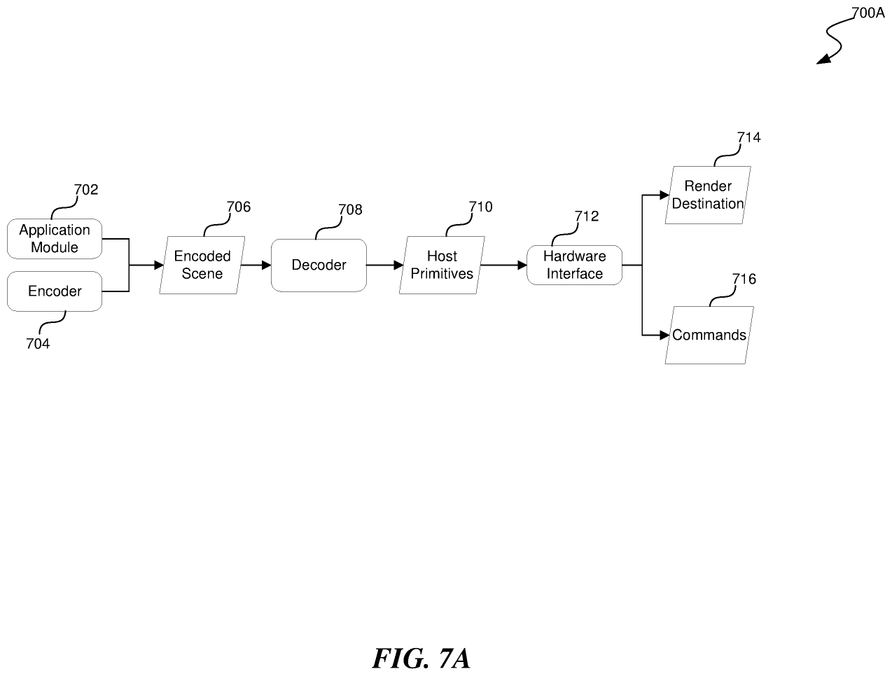

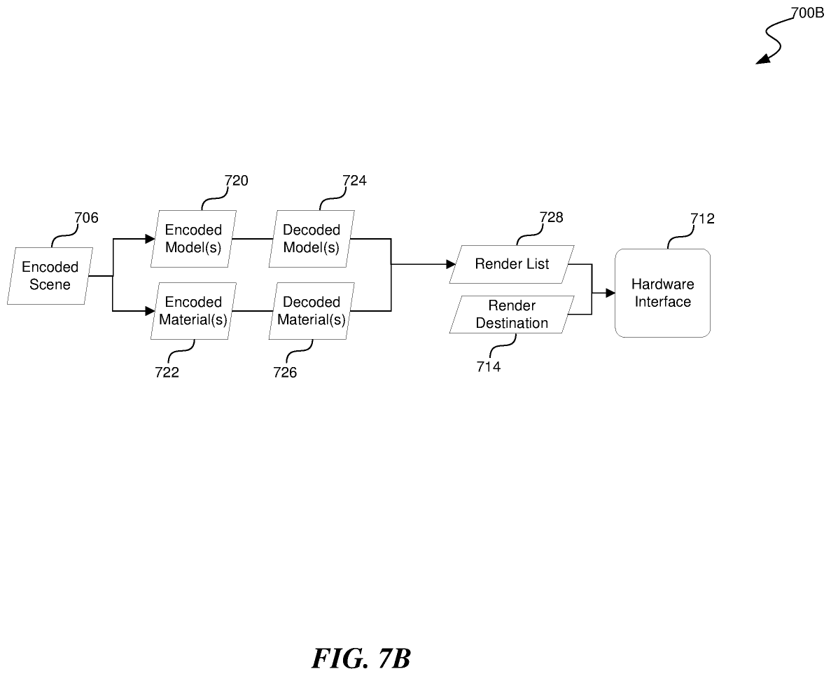

FIG. 7A is a conceptual diagram for encoding and rendering a scene graph using a hardware interface. Diagram 700A includes application module 702, encoder 704, encoded scene 706, decoder 708, host primitives 710, hardware interface 712, render destination 714, and commands 716. Encoded scene 706 can be any suitable scene graph encoded via application module 702 and/or encoder 704. For example, a given content source (e.g., XR application) can generate a scene graph that comprises multiple scene components. In some implementations, encoder 704 can be a component affiliated with a host renderer (e.g., plugin, software development kit (SDK), etc.) configured to receive, as input, a scene graph comprising a given format (e.g., hierarchical structure, DOM, etc.) and encode the scene components of the scene graph into encoded scene components compatible with the host renderer, such as entities. In some implementations, the content source itself, such as the application that generates the content, can comprise application module 702, which can encode the scene graph into encoded scene 706.

Encoded scene 706 can be received at the host renderer via decoder 708. Decoder 708 can decode the entities comprised in encoded scene 706 and populate host primitives 710 that represent the entities/components of the original scene graph. For example, a given one of host primitives 710 can comprise rendering information for rendering a given one of the scene components of the original scene graph (represented as an entity in encoded scene 706). In some implementations, the rendering information stored at host primitives 710 can include mesh structure(s), material(s), texture(s), buffer(s), shader(s), and any other suitable rendering information for rendering a component of a scene graph.

The host renderer can generate render calls (e.g., draw calls, a rendering pipeline, etc.) via hardware interface 712 using the rendering information stored by host primitives 710. For example, the processor rendering calls issued via hardware interface 712 can include render destination 714 and render commands 716. One or more processors can receive and execute the processor rendering calls to draw pixels that render the scene components of the original scene graph.

In some implementations, commands 716 can comprise multiple rendering commands that, when executed, render the scene components of the original scene graph. For example, encoded scene 706 can comprise metadata that represents a CommandBuffer, such as a list of render commands for a render pass (e.g., set render target, draw mesh, etc.). In some implementations, metadata of encoded scene 706 can include command metadata, and the host renderer can generate commands 716 using the command metadata. For example, the command metadata can indicate a type of draw call (e.g., forward render, deferred render, ray tracer, etc.) and other suitable command information that provides instructions to the host renderer for command generation. In some implementations, the metadata of encoded scene 706 can include orientation data (e.g., transformation matrix) for the entities/scene components. The orientation data can indicate the rendering orientation for the structure information (e.g., mesh, sub-models, materials, textures, etc.) of the entities/scene components.

Render destination 714 can define the location to which the processor(s) render the scene components/defined pixels. In some implementations, render destination 714 can be provided by the host renderer. For example, the host renderer can be delegated control over where to render pixels, and thus the host renderer can define render destination 714 and the location to which pixels are rendered. In some implementations, render destination 714 can be provided by the content source (e.g., XR application). For example, the render calls of the host renderer may participate with an existing set of render calls/rendering pipeline, such as a rendering pipeline from the XR application that sourced encoded scene 706. In this example, the XR application may provide render destination 714 to control the location to which pixels are rendered.

Based on processor rendering calls from hardware interface 712 (e.g., render destination 714, render commands 716, render list, etc.) one or more processors can perform a render pass that define pixels and renders components of the original scene graph. In some implementations, encoded scene 706 can be updated, for example via updates to entities/scene components from application module 702 and/or encoder 704. These updates can result in processor rendering calls from hardware interface 712 to the one or more processors such that updates of the scene components are rendered.

The host renderer's host primitives that store rendering information for the entities/scene components (e.g., host primitives 710) can include render information persisted at the host renderer indicated by the encoded scene graph (e.g., encoded scene 706). FIG. 7B is a conceptual diagram for generating rendering information using encoded scene component(s). Diagram 700B includes encoded scene 706, encoded model(s) 720, encoded material(s) 722, decoded model(s) 724, decoded material(s) 726, render list 728, render destination 714, and hardware interface 712.

Each entity of encoded scene 706 can comprise one or more of encoded model(s) 720 and encoded material(s) 722. Encoded model(s) 720 can indicate one or mesh models (e.g., vertices, indices, vertex layout, etc.) and/or one or more sub-models. Encoded material(s) 722 can indicate one or more material(s), texture(s), shader(s), blend modes, etc. For example, encoded information for a given entity can comprise encoded model(s) 720 that include a given model and two sub-models and encoded material(s) 722 that include one or more materials for each element of the model. In this example, different materials can be applied to the two sub-models from the encoded model information. Encoded model(s) 720 and/or encoded material(s) 722 for a given entity can comprise or indicate this information.

In some implementations, a given instance of a model (e.g., mesh with one or more sub-models) can be instantiated and persisted at the host renderer and encoded model(s) 720 can comprise one or more identifiers to the persisted model instance(s). For example, the content source (e.g., XR application) can interact with the host renderer (via a plugin, SDK, the host renderer encoder component, or any other suitable interface) to define one or more models, such as meshes, sub-models, etc. In some implementations, the content source submits a request to the host renderer to persist the defined model(s) at the host renderer. In response, the host renderer can persist an instance of a model (or other suitable representation) that stores the specific model information (e.g., meshes, sub-models, etc.) in affiliation with an identifier. The host renderer can then return the model identifier to the content source and/or host renderer interface components (e.g., plugin, SDK, encoder, etc.). In some implementations, encoded model(s) 720 indicate the model(s) that represent a given scene component of a scene graph via one or more identifiers to model(s) persisted at the host renderer. For example, the content source, plugin, SDK, encoder, or any other suitable component can encode the scene graph to include identifier(s) to these persisted model(s).

In some implementations, a given instance of a material (e.g., material(s), texture(s), shader(s), blend modes, etc.) can be instantiated and persisted at the host renderer and encoded material(s) 722 can comprise one or more identifiers to the persisted material instance(s). For example, the content source (e.g., XR application) can interact with the host renderer (via a plugin, SDK, the host renderer encoder component, or any other suitable interface) to define one or more materials, such as materials, textures, shaders, etc. In some implementations, the content source submits a request to the host renderer to persist the defined material(s) at the host renderer. In response, the host renderer can persist an instance of a material that stores the specific material information in affiliation with an identifier. The host renderer can then return the material identifier to the content source and/or host renderer interface components (e.g., plugin, SDK, encoder, etc.). In some implementations, encoded material(s) 722 indicate the material(s) that represent a given scene component of a scene graph via one or more identifiers to material(s) persisted at the host renderer. For example, the content source, plugin, SDK, encoder, or any other suitable component can encode the scene graph to include identifier(s) to these persisted material(s).

In some implementations, the decoder at the host renderer can decode encoded model(s) 720 and encoded material(s) 722 by: accessing the model identifier(s) comprised by encoded model(s) 720 and the material identifier(s) comprised by encoded material(s) 722; and retrieving the specific model/material information from the persisted model(s) and material(s) identified. For example, decoded model(s) 724 can comprise the retrieved model information from the persisted model(s) and decoded material(s) 726 can comprise the retrieved material information from the persisted material(s). In some implementations, decoded model(s) 724 and decoded material(s) 726 comprise host primitives that provide the specific information used to render components of the scene graph represented by encoded scene 706.

In some implementations, render list 728 is generated using the decoded model(s) 724 and the decoded material(s) 726. For example, the model information retrieved from the persisted model instances at the host renderer and the material information retrieved from the persisted model instances at the host renderer can be included in the render list 728. Hardware interface 712 can then issue processor render call(s) using render list 728 to cause the processor(s) to render the scene components of encoded scene 706 using the information stored in render list 728. As discussed with reference to FIG. 7A, render destination 714 can be provided by the host renderer or the content source (e.g., XR application) to define the location to which pixels are rendered by the processor(s).

In some implementations, encoded scene 706 can comprise the model information and material information for a scene component. For example, rather than an identifier to a persisted model/mesh, encoded scene 706 can comprise the actual model information and material information. In this example, render list 728 can be generated using the model information and material information comprised in encoded scene 706.

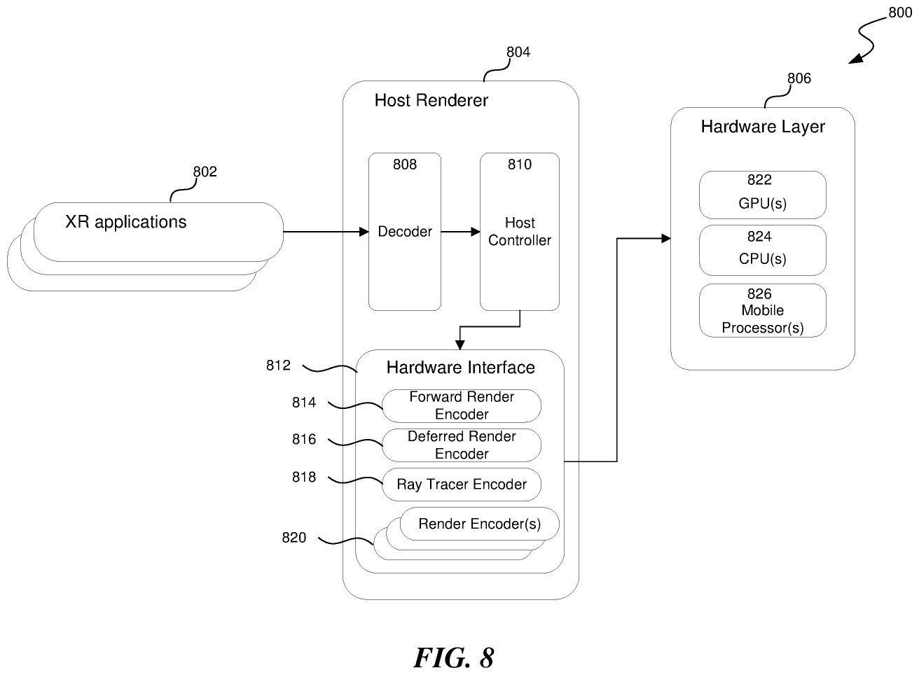

Implementations of the host renderer's hardware interface can interact with a variety of different processors and/or devices, as illustrated in FIG. 8, which is a system diagram comprising a host renderer that performs dynamic rendering for content source(s) via a variety of rendering types and processor types. Diagram 800 includes XR applications 802, host renderer 804, hardware layer 806, decoder 808, host controller 810, hardware interface 812, forward renderer encoder 814, deferred render encoder 816, ray tracer encoder 818, render encoder(s) 820, GPU(s) 822, CPU(s) 824, mobile processor(s) 826.

Host renderer 804 can generate processor rendering calls to render content (e.g., scene graphs) from multiple content sources, such as XR applications 802. The processor rendering calls can vary in the type of rendering call (e.g., forward rendering, deferred rending, ray tracer, etc.) and type of processor targeted by the call (e.g., GPU(s) 822, CPU(s) 824, mobile processor(s) 826). Implementations of host renderer 804 separate the hardware level interactions that render pixels from the content generating XR applications 802. This separation supports a flexible, interoperable, distributed, and efficient technique for rendering content (e.g., XR scenes) from multiple content sources.

XR applications 802 can encode content and provide the encoded content to decoder 808. For example, the content generated by one of XR applications 802 can be a XR scene graph comprising multiple scene components (e.g., virtual objects, renderable/drawable elements, components that affect rendering such as lighting or other effects, etc.). An encoding component (e.g., a module of XR applications 802, an encoder affiliated with host renderer 804, etc.) can encode the XR scene graph to generate encoded scene components, or entities. Host renderer 804 can receive the encoded XR scene graph at decoder 808. Decoder 808 can decode the encoded XR scene graph and generate/update host primitives. For example, the decoded XR scene graph can comprise or indicate rendering information for the scene components of the original XR scene graph. This rendering information can include mesh structure(s), material(s), texture(s), buffer(s), shader(s), and any other suitable rendering information. The host primitives can store the rendering information relevant to rendering the scene components of the original XR scene graph.

Host controller 810 can issue hardware rendering calls to hardware layer 806 via hardware interface 812 using the rendering information stored by the host primitives. Hardware interface 812 comprises different processor APIs and rendering call encoders, such as forward renderer encoder 814, deferred renderer encoder 816, ray tracer encoder 818, and render encoder(s) 820. Hardware layer 806 comprises a variety of processing hardware, such as GPU(s) 822, CPU(s) 824, and mobile processor(s) 826. Hardware interface 812 can issue different types of rendering calls to different ones of GPU(s) 822, CPU(s) 824, and/or mobile processor(s) 826 for different decoded scene graphs (e.g., host primitives that represent scene components of the decoded scene graphs).

Forward renderer encoder 814 can encode forward render call(s). For example, in response to a forward render call a processor (and associated hardware) can receive the structure of a drawable (e.g., one or more meshes/materials of a scene component), and break down the drawable into its vertices and fragments. An example forward render pass can include a sequential vertex shader, geometry shader, and fragment shader. Each drawable (e.g., mesh(es)/material(s)) can be passed down the render pipe linearly.

Deferred render encoder 816 can encode deferred render call(s). To perform a deferred render pass, a processor (and associated hardware) can buffer rendering using a G-buffer (or geometry buffer). The deferred render pass first buffers the geometry of drawables into the G-Buffer. These geometries are then rendered from the G-buffer, and, in a single pass, the geometries are shaded according to lighting sources. The deferred render pass can achieve high degrees of efficiency when compared to a forward render pass when overlapping light sources are present. Ray tracer encoder 818 can encode ray tracer calls. Hardware performs ray tracer rendering by emulating the properties of light via virtual photons and “tracing” the path of the light to shade geometries.

Host controller 810 can encode, via hardware interface 812, one or more forward render calls, deferred render calls, ray tracer render calls, or any combination, that target one or more of GPU(s) 822, CPU(s) 824, and mobile processor(s) 826. The targeted hardware can then perform the rendering to define pixels values and render the XR scene. In some implementations, hardware layer 806 can be distributed across multiple devices. For example, a XR system can include multiple computing devices that share the compute load for implementing and rendering an XR scene (e.g., XR environment). Host controller 810 can issue different processor rendering calls to different ones of these devices based on the hardware of the device.

For example, a first one of XR applications 802 can transmit a first encoded scene graph to decoder 808. Host primitives decoded from this first encoded scene graph can be used by host controller 810 to issue processor rendering calls via hardware interface 812. The processor rendering calls issued based on the first encoded scene graph can be, at least in part, forward render call(s), deferred render call(s), and/or ray tracer call(s) issued to GPU(s) 822 comprised by a first device of a XR system. A second one of XR applications 802 can transmit a second encoded scene graph to decoder 808. Host primitives decoded from this second encoded scene graph can be used by host controller 810 to issue processor rendering calls via hardware interface 812. The processor rendering calls issued based on the second encoded scene graph can be, at least in part, mobile processor render call(s) issued to mobile processor(s) 826 comprised by a second device of the XR system.

As these examples demonstrate, host renderer 804 provides a flexible host rendering service for content sources (e.g., XR applications 802) that abstract hardware level rendering calls to simplify the content source's rendering responsibilities. Over time, different rendering call(s), hardware API(s), and other suitable rendering functionality can be added to host renderer 804. The different content sources that rely on host renderer 804 for rendering can benefit from this extensible framework. For example, the content sources can leverage the updates to host renderer 804 to render content using the new techniques (e.g., new rendering calls, new hardware APIs, etc.) without needing to perform the same updates themselves. Because host renderer 804 is reused by multiple content sources, implementations achieve an efficient rendering solution for a variety of hardware types and/or rendering techniques.

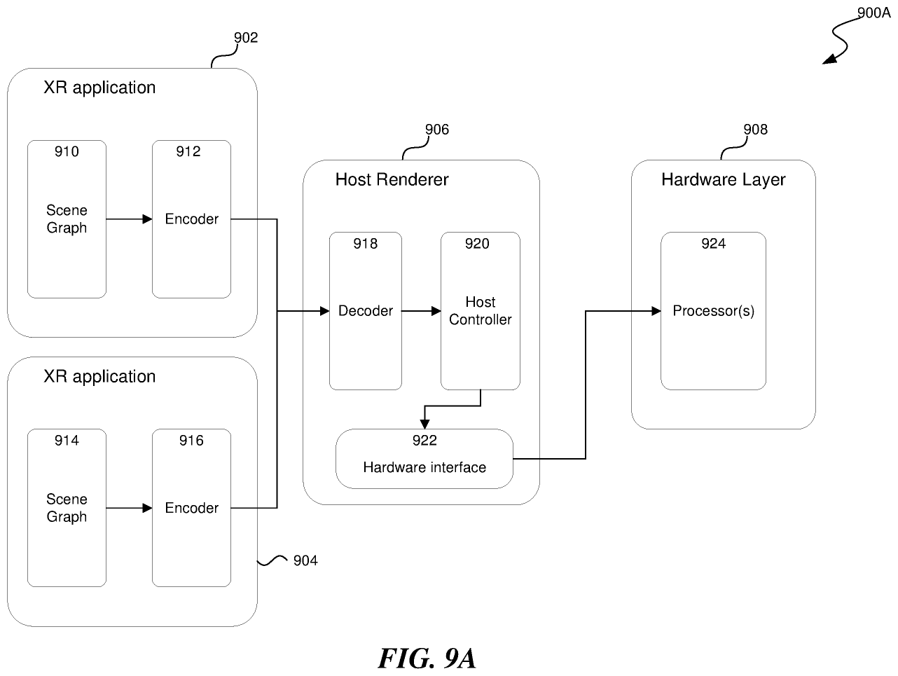

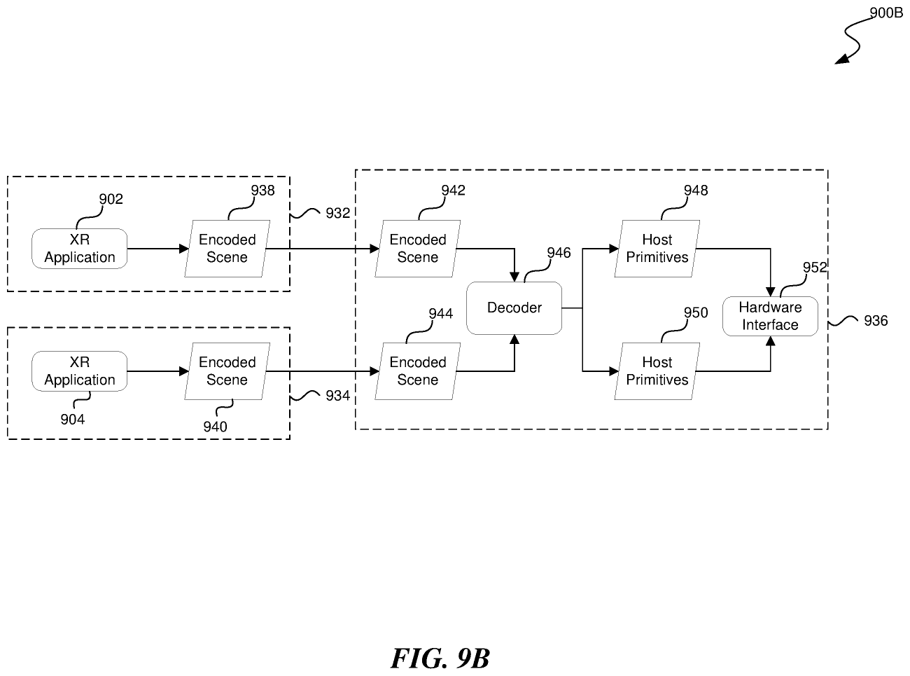

In some implementations, the host renderer can jointly render content from multiple content sources. For example, the encoding, decoding, and rendering techniques of the host renderer can perform joint rendering for content from two distinct content sources. FIG. 9A is a system diagram comprising a host renderer that performs joint dynamic rendering using content from multiple sources. Diagram 900A includes XR applications 902 and 904, host renderer 906, hardware layer 908, scene graphs 910 and 914, encoders 912 and 916, decoder 918, host controller 920, hardware interface 922, and processor(s) 924. Host renderer 906 can receive content (e.g., encoded XR scenes) from both of XR application 902 and XR application 904 and issue processor call(s) to jointly render the XR scenes from these different applications.

For example, XR application 902 can generate scene graph 910 comprising scene components (e.g., virtual objects, drawable/renderable elements, etc.). XR application 902 can perform functionality related to scene graph 910, such as physics for scene component interactions, user input processing, and the like. XR application 902 can manage scene graph 910 to maintain up-to-date information about its scene components. Similarly, XR application 904 can generate scene graph 914 comprising scene components (e.g., virtual objects, drawable/renderable elements, lighting or other effects, etc.). XR application 904 can perform functionality related to the scene graph 914, such as physics for scene component interactions, user input processing, and the like. XR application 904 can manage scene graph 914 to maintain up-to-date information about its scene components.

Prior to providing host renderer 906 the scene components of scene graph 910, the scene graph is encoded via encoder 912. Encoder 912 can generate encoded scene components, or entities, from scene graph 910. XR application 902 and/or encoder 912 can provide the encoded scene graph to host renderer 906 and decoder 918. Similarly, prior to providing host renderer 906 the scene components of scene graph 914, the scene graph is encoded via encoder 916. Encoder 916 can generate encoded scene components, or entities, from scene graph 914. XR application 904 and/or encoder 916 can provide the encoded scene graph to host renderer 906 and decoder 918. The entities of the encoded scene graphs can comprise and/or indicate information for rendering the scene components of scene graphs 910 and 914. For example, each entity can indicate/comprise: one or more mesh structures; and one or more materials to be applied to the one or more mesh structures (e.g., materials, textures, shaders, etc.). The encoded scene graphs can also comprise metadata information for rendering these entities. Decoder 918 can decode each entity of the encoded scene graphs provided by XR applications 902 and 904 to generate host primitives used by host renderer 906 to render the scene components of scene graphs 910 and 914. For example, the encoded scene graphs can reference mesh and/or material information persisted at host renderer 906, and the host primitives can be generated/updated by accessing this persisted mesh and/or material information. In another example, the entities of the encoded scene graphs can comprise the mesh and/or material information, and the host primitives can be generated/updated using the comprised mesh and/or material information.

Once decoder 918 decodes the encoded scene graph into host primitives, host controller 920 can issue rendering call(s) (e.g., draw calls) to hardware layer 908 and processor(s) 924 via hardware interface 922. Host controller 920 can generate the structure of the rendering calls using hardware interface 922 (e.g., processor API(s)) and issue the rendering calls to processor(s) 924 at hardware layer 908. In some implementations, the decoded scene graphs and host primitives correspond to scene components of both scene graph 910 and scene graph 914. Accordingly, the rendering calls issued by host controller 920 to hardware layer 908 and processor(s) 924 jointly render the scene components of scene graph 910 and scene graph 914.

In some implementations, processor(s) 924 can be any suitable processors for executing rendering calls/rendering pipeline(s), such as central processing units (CPUs), graphics processing units (GPUs), mobile processors, multi-core processors, any combination thereof, or any other suitable processors. For example, a rendering pipeline can comprise compute functions and graphics functions, and hardware layer 908 can be configured to execute both the compute functions and graphics functions using one or more of processor(s) 924.

In some implementations, hardware layer 908 can comprise multiple devices. For example, a first device can comprise first processor(s) 924 and a second device can comprise second processor(s) 924. In this example, the first and second devices can be part of a XR system comprising multiple devices that each include separate processor hardware. For example, processor compute load for generating and displaying an XR scene (e.g., immersing a user in an XR environment) can be performed at both the first device and the second device. In some implementations, XR application 902, XR application 904, and/or host renderer 906 can execute at the first device, and at least a portion of rendering calls can be issued by host renderer 906 via hardware interface 922 to the second device. In this example, processor(s) 924 located at the second device can execute the portion of the rendering calls to render at least a portion of the XR scenes represented by scene graphs 910 and 914. XR applications 902 and 904 can execute at the same device as host renderer 906, or any other suitable device.

In some implementations, one or more of the content sources (XR applications) can provide the encoded scene graph(s) to the host renderer via an inter-process communication protocol. For example, one or both of XR applications 902 and 904 can execute via a software process that is different from the software process that executes host renderer 906. In this example, the inter-process communication protocol can permit data sharing among XR application 902, XR application 904, and host renderer 906. FIG. 9B is a system diagram comprising a host renderer that performs joint dynamic rendering of multiple scene graphs using inter-process communication to maintain scene graph(s) state. Diagram 900B includes software processes 932, 934, and 936, XR applications 902 and 904, encoded scenes 938, 940, 942, and 944, decoder 946, host primitives 948 and 950, and hardware interface 952.

Process 932 can be a software process that executes XR application 902, process 934 can be a software process the executes XR application 904, and process 936 can be a software process the executes host renderer 906. In some implementations, process 932 and 934 can be a single process that execute both XR application 902 and XR application 904 that is separate from process 936. Because XR applications 902 and 904 execute via process(es) different from host renderer 906, an inter-process communication protocol can support communication among these software elements.

For example, XR application 902 can locally maintain encoded scene 938 via process 932 and XR application 904 can locally maintain encoded scene 940 via process 934. XR application 902 can update the application's scene graph via application functionality (e.g., input processing, scene component physics/interactions, game simulations, etc.) and update encoded scene 938 accordingly. Similarly, XR application 904 can update the application's scene graph via application functionality (e.g., input processing, scene component physics/interactions, game simulations, etc.) and update encoded scene 940 accordingly.

To support inter-process communication, one or more messages can be transmitted from process 932 to process 936 and/or from process 934 to process 936. These messages can comprise the encoded scene 938 and the encoded scene 940. Host renderer 906 can maintain encoded scene 942 as a local version of encoded scene 938 and encoded scene 944 as a local version of encoded scene 940. For example, the upon receiving inter-process message(s) from process 932 and process 934, the host renderer can generate and/or update encoded scene 942 and encoded scene 944 to maintain these local versions. Accordingly, encoded scene 938 represents a maintained state of XR application 902's scene graph maintained at XR application 902 and process 932, encoded scene 940 represents a maintained state of XR application 904's scene graph maintained at XR application 904 and process 934, encoded scene 942 represents a maintained state of XR application 902's scene graph maintained at the host renderer and process 936, and encoded scene 944 represents a maintained state of XR application 904's scene graph maintained at the host renderer and process 936.

In some implementations, decoder 946 can decode the entities comprised in encoded scene 942 and encoded scene 944 and populate host primitives 948 and 950 that represent the entities/components of the original scene graphs. For example, a given one of host primitives 948 can comprise rendering information for rendering a given one of the scene components of the original scene graph of XR application 902 (represented as an entity in encoded scene 942) and a given one of host primitives 950 can comprise rendering information for rendering a given one of the scene components of the original scene graph of XR application 904 (represented as an entity in encoded scene 944). In some implementations, the rendering information stored at host primitives 948 and 950 can include mesh structure(s), material(s), texture(s), buffer(s), shader(s), and any other suitable rendering information for rendering a component of a scene graph.

The host renderer can generate render calls (e.g., draw calls, a rendering pipeline, etc.) via hardware interface 950 using the rendering information stored by host primitives 948 and 950. For example, the processor rendering calls issued via hardware interface 950 can include a render destination and render commands. In some implementations, the render destination and/or render commands are comprised by (or are generated at the host renderer using) render metadata of encoded scene 942 and encoded scene 944. One or more processors can receive and execute the processor rendering calls to draw pixels that jointly render the scene components of the original scene graphs of XR applications 902 and 904.

In some implementations, XR application 902 updates the application's scene graph, for example via scene component interactions, user input, game simulations, or any other suitable application functionality. XR application 902 can maintain encoded scene 938 by encoding updates to the application's scene graph and updating encoded scene 938. Similarly, XR application 904 can update the application's scene graph, for example via scene component interactions, user input, game simulations, or any other suitable application functionality. XR application 904 can maintain encoded scene 940 by encoding updates to the application's scene graph and updating encoded scene 940.

XR application 902 and process 932 can push inter-process communication messages that update the host renderer and encoded scene 942. For example, the pushed inter-process communication can include updates of encoded scene 938 that can be used to bring encoded scene 942 up to date. Similarly, XR application 904 and process 934 can push inter-process communication messages that update the host renderer and encoded scene 944. For example, the pushed inter-process communication can include updates of encoded scene 940 that can be used to bring encoded scene 944 up to date.

In some implementations, XR application 902 and process 932 can push state updates for encoded scene 938 at a first frequency rate. For example, the first frequency rate can be defined by: XR application 902, the host renderer, or any other suitable entity. The first frequency rate can control how often the rendered components from encoded scene 938/942 are updated (via new rendering calls from hardware interface 952). XR application 904 and process 934 can push state updates for encoded scene 938 at a second frequency rate. For example, the second frequency rate can be defined by: XR application 904, the host renderer, or any other suitable entity. The second frequency rate can control how often the rendered components from encoded scene 940/944 are updated (via new rendering calls from hardware interface 952).

In some implementations, the first frequency rate is faster than the second frequency rate, and thus the rendered scene components of encoded scene 938/942 are updated faster than the rendered scene components of encoded scene 940/944. In other words, the rendered components from XR application 902's scene graph are updated faster than the rendered components from XR application 904's scene graph are updated. In some implementations, XR application 902 defines the first frequency rate and XR application 904 defines the second frequency rate. These XR applications may define these frequency rates based on the status of the executing XR applications. For example, the scene graph of XR application 902 may include foreground components while the scene graph of XR application 904 includes background components. Thus, XR application 902 may define a faster frequency rate than XR application 904 so that the foreground components are updated faster than the background components. The first and second frequency rates can be dynamically changes, for example in response to user input or other application functionality that prompts a change in the updates rates with respect to each application's scene components.

In some implementations, the rate at which rendering calls from hardware interface 952 render updates for host primitives 948 (e.g., which store data for updated scene components of encoded scene 942) and host primitives 950 (e.g., which store data for updated scene components of encoded scene 944) can represent a third frequency rate. For example, the third frequency rate can represent a rate at which process 936 issues rendering calls. When the first frequency rate (which is used to update host primitives 944) is faster than the second frequency rate (which is used to update host primitives 950), the rendering calls issued from hardware interface 952 via the execution of process 936 at the third frequency rate can render updates of scene components of encoded scene 938/942 faster than updates of scene components of encoded scene 940/944.

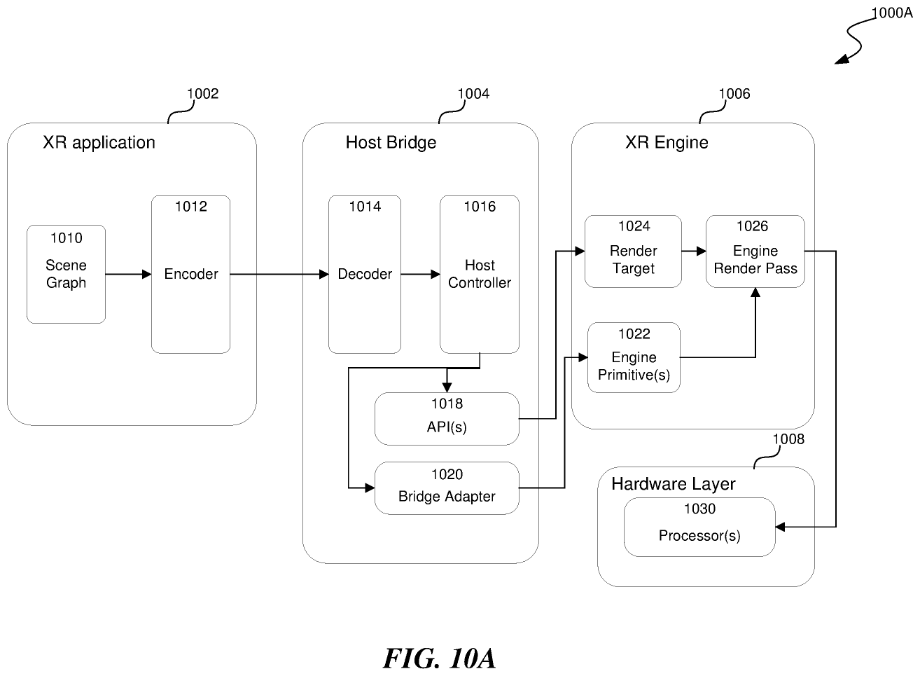

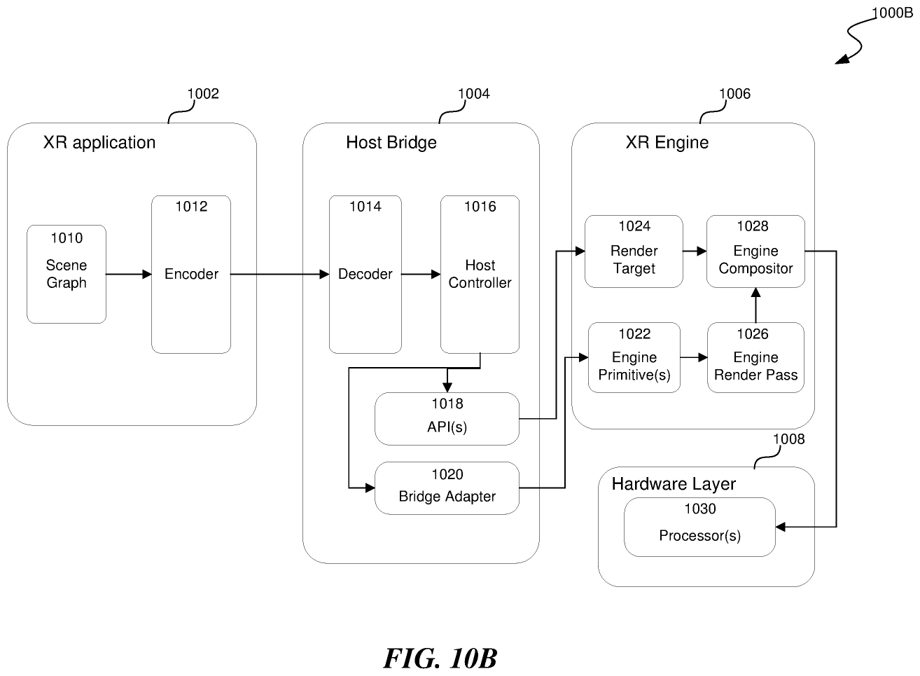

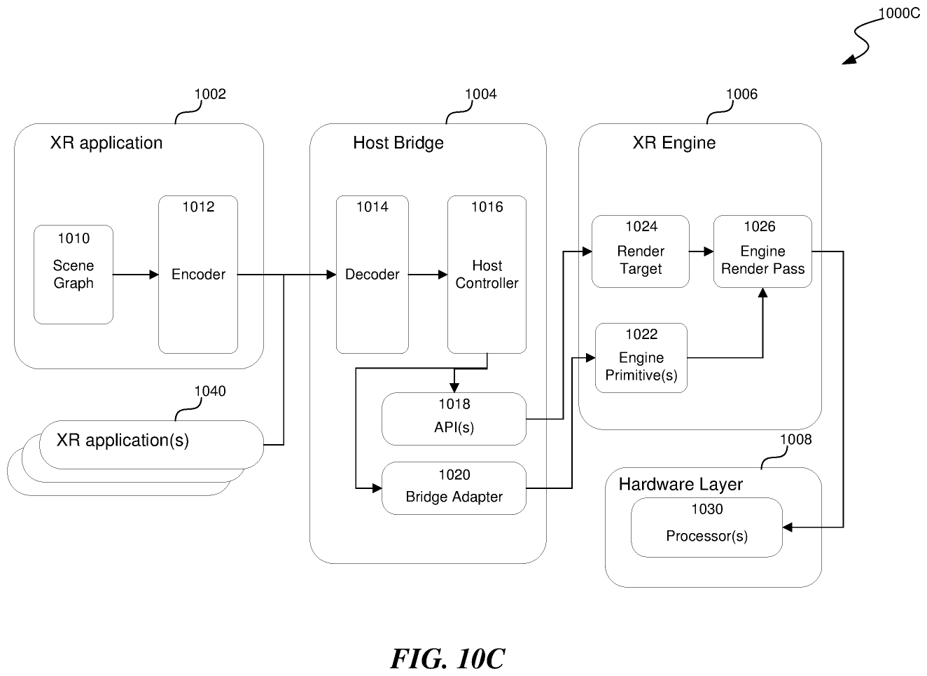

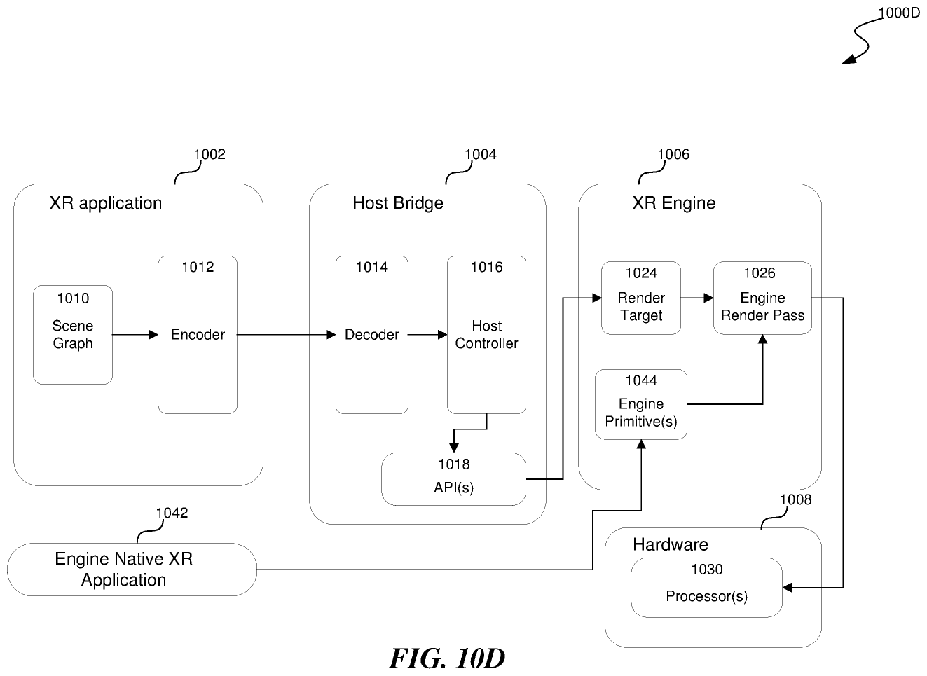

FIGS. 10A, 10B, 10C, and 10D are system diagrams 1000A, 1000B, 1000C, and 1000D comprising a host bridge that converts an external component for rendering by a rendering engine. Diagram 1000A includes XR application 1002, host bridge 1004, XR engine 1006, hardware layer 1008, scene graph 1010, encoder 1012, decoder 1014, host controller 1016, API(s) 1018, bridge adapter 1020, engine primitive(s) 1022, render target 1024, engine render pass 1026, and processor(s) 1030.

XR application 1002 can represent a content source that provides content to host bridge 1004 for conversion such that the content is renderable by XR engine 1006. For example, XR engine 1006 can be any suitable XR content rendering engine configured to render content in a given format, such as content contained in engine specific primitives. These engine specific primitives are designed and structured to be compatible with rendering components of XR engine 1006. In some implementations, the rendering components at XR engine 1006 can generate rendering pipeline(s) using the engine specific primitives. For example, the engine specific primitives can include rendering information (e.g., mesh structures, materials, etc.) for renderable elements of the content.

In some implementations, the content of XR application 1002 is not formatted according to the content specification of XR engine 1006 (e.g., is not contained in XR engine specific primitives). Host bridge 1004 can convert content from XR application 1002 such that the converted content meets the content specifications of XR engine 1006. For example, host bridge 1004 can receive encoded content from XR application 1002 and generate engine compatible rendering information using the encoded content. The engine compatible rendering information can comprise engine specific primitives and/or hardware level API rendering calls that XR engine 1006 can process to render the content.

The content from XR application 1002 can be represented by scene graph 1010. Scene graph 1010 can represent an XR scene similar to scene graph 502 of FIG. 5. For example, scene graph 1010 can include scene components, or renderable elements of the XR scene. Prior to providing host bridge 1004 with the scene components of scene graph 1010, the scene graph is encoded via encoder 1012. Encoder 1012 can generate encoded scene components, or entities, from scene graph 1010. XR application 1002 and/or encoder 1012 can provide the encoded scene graph to host bridge 1004 and decoder 1014. For example, decoder 1014 can decode each entity of the encoded scene graph to generate/update host primitives used by host bridge 1004.

The encoding of scene graph 1010 can provide a source-neutral format for the scene graph. For example, a variety of different content sources can encode scene graph(s) via encoder 1012 (or a similar encoder) prior to providing the scene graph(s) to host bridge 1004. Such an architecture enables host bridge 1004 to convert content for rendering via XR engine 1004 (or any other suitable XR engine) from a wide variety of XR application(s) and/or content sources. As long as a given content source encodes the content (e.g., scene graph) into host renderer 1004's encoding format, host bridge 1004 can support conversion for the given content source with a corresponding bridge adapter (e.g., bridge adapter 1020). For example, decoder 1012 at host bridge 1004 can decode entities (e.g., encoded scene components) from a variety of different content sources.

Host controller 1016 of host bridge 1004 can generate and/or update host primitives using the decoded entities from decoder 1014. For example, host primitives can serve as a neutral primitive structure for conversion to engine specific primitives via one or more adapters (e.g., bridge adapter 1020). In some implementations, the host primitives store rendering information for each scene component, such as the structure information (e.g., mesh, sub-models, buffer(s), etc.) and/or material information (e.g., material(s), texture(s), shader(s), etc.). However, XR engine 1006 may be incompatible with the structure of host bridge 1004's host primitives. In some implementations, to provide XR engine 1006 with data renderable by the engine, bridge adapter 1020 can convert the host primitives to XR engine primitives.

The converted XR engine primitives can represent the scene components of scene graph 1010. For example, the scene components can be: encoded via encoder 1012, transmitted from XR application 1002 to host bridge 1004, decoded via decoder 1014, used by host controller 1016 to populate host primitives, and converted by bridge adapter 1020 into XR engine primitives. The converted engine primitives can: contain the decoded information from scene components of scene graph 1010; and comprise a formatting compatible with rendering via XR engine 1006. Host bridge 1004 and bridge adapter 1020 can provide the XR engine primitives to XR engine 1006, which can store them as engine primitive(s) 1022. XR engine 1006 can then generate engine render pass 1026 using engine primitive(s) 1022. Engine render pass 1026 can comprise processor render calls to render the scene components of scene graph 1010.

In some implementations, host controller 1016 can generate call(s) (e.g., API draw calls) using API(s) 1018 to pass scene component rendering information to XR engine 1006. For example, the calls generated by host controller 1016 using API(s) 1018 can comprise processor render calls. Host bridge 1004 can utilize one or more of the generated call(s) to pass rendering information about the scene components of scene graph 1010 to XR engine 1006. For example, host controller 1016 can render (via API(s) 1018) the scene component content (e.g., model(s), material(s), etc.) into render target 1024 at XR engine 1006. The generated call(s) via API(s) 1018 can be implemented as an alternative to bridge adapter 1020 and its conversion of host primitives to engine primitives, or in some scenarios in addition to this functionality of bridge adapter 1020.

Render target 1024 can comprise a target for the scene component content, such as an engine compatible texture and/or material. The texture and/or material can then be applied to XR engine primitives (e.g., XR engine compatible model information) to render the scene component. For example, XR engine 1006 can generate engine render pass 1026 such that render target 1024 is applied to model information (e.g., model information from an engine primitive). When render pass 1026 is executed via processor(s) 1030, the render target 1024's application to the model information can cause the scene component to be rendered. In another example, XR engine 1006 can generate engine render pass 1026 such that render target 1024 is directly placed in the rendered scene (e.g., directly rendered) via a quad engine primitive (e.g., generic three-dimensional model). The generated engine render pass 1026 can texture the quad engine primitive with render target 1024. This gives the appearance that host bridge 1004 directly causes the rendering of a portion of the scene ultimately rendered via hardware 1008.

In some implementations, host bridge 1004 can convert content from XR application 1002 that is incompatible with rendering by XR engine 1006 into engine specific primitives that are renderable by XR engine 1006. This conversion is achieved via encoder 1012, decoder 1014, host controller 1016, and bridge adapter 1020, which convert XR application 102 content (e.g., scene components of scene graph 1010) into engine primitive(s) 1022. In some implementations, host bridge 1004 can generate call(s) using API(s) 1018 to pass scene component rendering information to XR engine 1006. The generated calls can render scene component information into render target 1024, which can then be applied to model information (e.g., engine primitives) to render the scene component.

Processor(s) 1030 can perform the rendering calls/rendering pipeline from engine render pass 1026 to render the scene components of scene graph 1010. In some implementations, processor(s) 1030 can be any suitable processors for executing rendering calls/rendering pipeline(s), such as central processing units (CPUs), graphics processing units (GPUs), mobile processors, multi-core processors, any combination thereof, or any other suitable processors. For example, a rendering pipeline can comprise compute functions and graphics functions, and hardware layer 1008 can be configured to execute both the compute functions and graphics functions using one or more of processor(s) 1030.

In some implementations, hardware layer 1008 can comprise multiple devices. For example, a first device can comprise first processor(s) 1030 and a second device can comprise second processor(s) 1030. In this example, the first and second devices can be part of a XR system comprising multiple devices that each include separate processor hardware. For example, processor compute load for generating and displaying an XR scene (e.g., immersing a user in an XR environment) can be performed at both the first device and the second device. In some implementations, XR application 1002, host bridge 1004, and/or XR engine 1006 can execute at the first device, and at least a portion of rendering calls can be issued by XR engine 1006 to the second device. In this example, processor(s) 1030 located at the second device can execute the portion of the rendering calls to render at least a portion of the XR scene represented by scene graph 1010. In some implementations, the devices of the XR system can comprise a display device, such as an HMD, and a companion processing device.

In some implementations, XR engine 1006 can include a compositor to render scene components from XR application 1002. Diagram 1000B includes XR application 1002, host bridge 1004, XR engine 1006, hardware layer 1008, scene graph 1010, encoder 1012, decoder 1014, host controller 1016, API(s) 1018, bridge adapter 1020, engine primitive(s) 1022, render target 1024, engine render pass 1026, engine compositor 1028, and processor(s) 1030.

In some implementations, engine compositor 1028 can composite content rendered via engine primitives 1022 (e.g., engine primitives converted from host primitives) and content rendered via render target 1024. For example, in some scenarios represented by diagram 1000A, engine render pass 1026 renders the entire scene at once, and thus not compositing is performed. However, in other scenarios engine render pass 1026 renders a portion of scene content, such as the portion from engine primitive(s) 1022. In this scenario, engine compositor 1028 can composite rendering information such that composited render target(s) include targets of engine render pass 1024 or content rendered into render target 1024 (provided by host bridge 1004 to XR engine 1006). Engine compositor 1028 can pass processor render calls, or a rendering pipeline, to processor(s) 1030 for execution to jointly render the content.

In some implementations, engine compositor 1028 can composite rendering information from a variety of different sources. For example, XR engine 1006 can receive engine primitives from an engine native XR application, as described with reference to diagram 1000D and FIG. 10D, and engine render pass 1024 can be generated using the content of these engine primitives. In another example, host bridge 1004 can receive scene components from a variety of different XR applications, as described with reference to diagram 1000C and FIG. 10C, and one or more of render target 1024 and/or engine primitive(s) 1022 can be based on the rendering information of the scene components from these different XR applications. Engine compositor 1028 can pass processor render calls, or a rendering pipeline, to processor(s) 1030 for execution to jointly render this diverse content.

In some implementations, XR engine 1006 can render content from multiple XR applications. Diagram 1000C includes XR application 1002, XR application(s) 1040, host bridge 1004, XR engine 1006, hardware layer 1008, scene graph 1010, encoder 1012, decoder 1014, host controller 1016, API(s) 1018, bridge adapter 1020, engine primitive(s) 1022, render target 1024, engine render pass 1026, and processor(s) 1030. Similar to XR application 1002 as describe with reference to diagram 1000A of FIG. 10A, XR application(s) 1040 can comprise multiple applications that provide scene components (e.g., encoded scene components) to host bridge 1004.

In some implementations, the content of XR application(s) 1040 is not formatted according to the content specification of XR engine 1006 (e.g., is not contained in XR engine specific primitives). Host bridge 1004 can convert content from XR application(s) 1040 such that the converted content meets the content specifications of XR engine 1006. For example, host bridge 1004 can receive encoded content from XR application(s) 1040 and generate engine compatible rendering information using the encoded content. The engine compatible rendering information can comprise engine specific primitives and/or hardware level API rendering calls that XR engine 1006 can process to render the content, as described with reference to diagram 1000A of FIG. 10A.

In some implementations, host bridge 1004 can convert content from XR application(s) 1040 that is incompatible with rendering by XR engine 1006 into engine specific primitives that are renderable by XR engine 1006. This conversion is achieved via application encoder(s), decoder 1014, host controller 1016, and bridge adapter 1020, which convert XR application(s) 1040 content (e.g., scene components) into engine primitive(s) 1022. In some implementations, host bridge 1004 can generate call(s) using API(s) 1018 to pass scene component rendering information to XR engine 1006. The generated calls can render scene component information into render target 1024, which can then be applied to model information (e.g., engine primitives) to render the scene component. XR engine 1006 can pass processor render calls (e.g., engine render pass 1026), or a rendering pipeline, to processor(s) 1030 for execution to jointly render this diverse content.

In some implementations, XR engine 1006 can render content that is not native to the XR engine (e.g., content from XR application 1002) along with content that is native to the XR engine. Diagram 1000D includes XR application 1002, engine native XR application 1042, host bridge 1004, XR engine 1006, hardware layer 1008, scene graph 1010, encoder 1012, decoder 1014, host controller 1016, API(s) 1018, engine primitive(s) 1044, render target 1024, engine render pass 1026, and processor(s) 1030.

As described with reference to FIG. 10A, scene components from scene graph 1010 of XR application 1002 can be rendered by XR engine 1006 after conversion via host bridge 1004. In some implementations, XR engine 1006 can jointly render content from engine native XR application 1042 (e.g., native scene components) along with the content from XR application 1002. For example, XR engine 1006 can generate and issue processor render calls that jointly render this content.

Engine native XR application 1042 can be a XR application that generates content in a format compatible with rendering via XR engine 1006. The content from engine native XR application 1142 (e.g., scene components of a scene graph, etc.) can be formatted according to primitives and/or metadata structures native to XR engine 1006. For example, the engine native content can comprise: engine native primitives that store structure information (e.g., mesh(es)) and material information (e.g., material(s), texture(s), etc.) for renderable components; and rendering metadata that defines rendering information (e.g., type of draw call, render location, etc.). In some implementations, engine native XR application 1142 can provide engine native content to XR engine 1006, represented as engine primitive(s) 1044 at XR engine 1006. XR engine 1006 can generate engine rendering pass 1026 using the engine native content stored by engine primitive(s) 1044.

In some implementations, scene components from XR application 1002 can be jointly rendered with the native content from engine native XR application 1042. For example, host bridge 1004 can provide scene component rendering information for scene components of XR application 1002 (e.g., via encoder 1012, decoder 1014, host controller 1016, and API(s) 1018) to XR engine 1006 as hardware level draw call(s) using API(s) 1018. Host bridge 1004 can, via the call(s), render content into render target 1024, which can then be applied to one or more model(s), as described with reference to FIG. 10A. In some implementations, engine render pass 1026 can jointly render content for scene components from XR application 1002 and content for scene components from engine native XR application 1042. In some implementations, an engine compositor, as described with reference to FIG. 10B, can composite render targets to jointly render content for scene components from XR application 1002 and content for scene components from engine native XR application 1042.

In some implementations, host bridge 1004 can convert host primitives that store rendering information for scene components from XR application 1002 into engine primitives. XR engine 1006 can then generate an engine render pass using the engine primitives that store rendering information for content from XR application 1002 (e.g., engine primitive(s) 1022 of FIG. 10A) and engine primitives that store rendering information for content from engine native XR application 1042 (e.g., engine primitive(s) 1044). XR engine 1006 can pass processor render calls, or a rendering pipeline, to processor(s) 1030 for execution to jointly render this diverse content.

In some implementations, engine native XR application 1042 can encode scene components and provide them to host bridge 1004. Host bridge 1004 can then decode the scene components into host bridge primitives and convert these into engine primitives. Host bridge 1004 can provide these converted engine primitives to XR engine 1006 for rendering. Accordingly, engine native XR application 1042 can use host bridge 1004 as an intermediary between XR engine 1006 and host bridge 1004, for example so that host bridge 1004 can provide converted engine primitives from multiple sources to XR engine 1006 (as described with reference to FIG. 10C) for joint rendering.

FIG. 11 is a conceptual diagram of elements that comprise a host renderer. Diagram 1100 includes client(s) 1102, feature unit(s) 1104, host renderer architecture 1106, hardware interface 1108, and processor API(s) 1110. Implementations of the host renderer decouple hardware level rendering calls (e.g., processor API(s) 1110 calls) from the content sources that generate the content for rendering.

Client(s) 1102 can represent content sources, such as XR applications. In some implementations, client(s) 1102 can encode content (e.g., a scene graph) for the host renderer via feature unit(s) 1104, or remote software affiliated with the host renderer (e.g., plug-ins, an SDK, etc.). In some implementations, client(s) 1102 can implement their own encoder that encodes the content for the host renderer. Feature Unit(s) 1104 can comprise one or more additional plugins/SDK elements for coordination with the host renderer. For example, feature unit(s) 1104 can comprise software for generating and/or registering meshes, materials, textures, shaders, etc. with the host renderer for reference by encoded content and/or host primitives.

Host renderer architecture 1106 can include decoder(s), host controller(s), and other suitable components of the host renderer that decode encoded content and populate host primitives using the decoded content. Since the encoded content received by host renderer architecture 1106 is structured according to the host renderer's compatible encoding structure, host renderer architecture 1106 can interact with a variety of different clients 1102. In some implementations, host renderer architecture 1106 can decode and populate host primitives using content from different clients 1102, thus supporting joint rendering of content from different sources. Accordingly, the host renderer can achieve interoperability for client(s) 1102 that would otherwise lack such coordinated rendering.

Hardware interface 1108 can use API(s) 1110 to generate and issue processor rendering calls using the populated host primitives. API(s) 1110 support a variety of different call types (e.g., forward rendering, deferred rendering, ray tracer, etc.) to a variety of different types of hardware/processors (e.g., CPUs, GPUs, mobile processors, etc.). In these implementations, the host renderer provides client(s) 1102 access to a variety of different hardware level resources while abstracting the hardware level interactions. This interoperability with a variety of different hardware types can better align rendering workload with hardware type and achieve improved overall performance.

Those skilled in the art will appreciate that the components illustrated in FIGS. 1-6, 7A, 7B, 8, 9A, 9B, 10, and 11 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 12 is a flow diagram illustrating processes 1200 and 1202 used in some implementations for dynamically rendering scene components from an encoded XR scene graph using a host renderer. In some implementations, process 1200 can be performed by a content source (e.g., XR application) and process 1202 can be performed by a host renderer. The XR application and host renderer can execute at a single device, or they can execute remote from one another. In some implementations where the XR application and host renderer execute at the same device, the XR application and host renderer can execute as part of the same software process or as part of different software processes.

At block 1204, process 1200 can generate a XR scene. For example, a XR application can generate a XR scene comprising a XR scene graph with multiple scene components. The scene components can include a skybox, background, virtual objects, lighting elements, etc. In some implementations, the scene components are renderable/drawable elements of the scene graph and/or elements that affect rendering. The XR scene graph can store a relative location for scene components within the XR scene, relationships/dependencies among the scene components, and other suitable XR scene information.

At block 1206, process 1200 can perform XR scene functionality. For example, the XR application can perform application functionality with respect to the scene components of the scene graph. This application functionality can include: processing user input, performing physics simulations to simulate component interactions, gaming simulations, object interactions, or any other suitable application functionality. In some implementations, the application functionality updates the state of scene components of the XR scene graph and/or generates new scene components.

A block 1208, process 1200 can encode the XR scene graph. For example, an encoder module can encode the XR application's scene graph into a format for the host renderer. The encoded XR scene graph can include encoded scene components, or entities, and metadata for rendering the encoded scene components. In some implementations, for each encoded scene component/entity, the encoded scene graph comprises or indicates one or more structures (e.g., mesh structures, sub-models, or other suitable structures) and one or more materials (e.g., materials, textures, shaders, etc.).

At block 1210, process 1200 can transmit the encoded scene graph to the host renderer. For example, the XR application (or a process that executes the XR application) can transmit the encoded scene graph to the host renderer. At block 1212, process 1202 can receive the encoded scene graph from the XR application. For example, the host renderer can receive the encoded scene graph from the XR application.

At block 1214, process 1202 can decode the entities of the encoded scene graph. For example, the host renderer can decode the entities comprised in the encoded scene graph and populate host primitives that represent the entities/components of the original XR scene graph. For example, a given one of host primitives can comprise rendering information for rendering a given one of the scene components of the original XR scene graph. In some implementations, the rendering information stored at the host primitives can include mesh structure(s), material(s), texture(s), buffer(s), shader(s), and any other suitable rendering information for rendering a component of a scene graph.

In some implementations, each entity of the encoded scene graph can indicate encoded structure information and encoded material information. The encoded structure information can be one or more mesh structures (e.g., a model and one or more sub-models), or any other suitable structure information. The encoded material information can be materials for the one or more mesh structures (e.g., materials, textures, shaders, etc.), or any other suitable material information. In some implementations, the encoded entities comprise identifiers to persisted instances of meshes and/or materials stored at the host renderer. In some implementations, the encoded entities comprise the actual mesh information and/or material information. The host primitives can be generated by decoding the encoded structure information and encoded material information for each encoded scene component/entity.

At block 1216, process 1202 can generate processor render draw calls using the host primitives. For example, the host renderer can generate processor render calls using processor API(s) to render the scene components of the original XR scene graph. In some implementations, the entities and rendering information stored at the host primitives can be passed as a render list as part of the rendering calls. For example, the host primitives can comprise mesh information and/or material information, and the render draw calls can cause the one or more processors to render the scene components using the mesh information and material information.

The encoded scene can include render metadata used to generate the processor render calls. For example, the render metadata can include one or more of: render commands, information used to generate the render commands, render call types (e.g., forward render, deferred render, ray tracer, etc.), render destination information, or any other suitable metadata for generating processor render calls. In some implementations, the processor render calls can comprise a rendering pipeline.

At block 1218, process 1202 can issue the processor render draw calls to one or more processor(s). For example, the host renderer can issue processor render draw calls to one or more processors that, in response to the draw calls, define pixels to render the scene components of the original XR scene graph. The one or more processors can include one or more CPUs, GPUs, multi-core processors, mobile processors, or any other suitable processors. In some implementations, the render draw calls comprise a rendering pipeline that cause the one or more processors to execute the rendering pipeline and render the scene components.

In some implementations, the host renderer executes at a first device and at least a portion of the render draw calls are issued to a second device. For example, the first and second devices can comprise a XR system. In some implementations, the first device can be a processing component of the XR system, and the second device can be a HMD of the XR system. The one or more processors can comprise one or more mobile processors of the second device that execute the portion of the render draw calls.

In some implementations, the one or more processors execute the rendering pipeline and render a three-dimensional XR scene comprising the rendered scene components. For example, three-dimensional XR scene can be displayed to the user via an HMD of a XR system as two displays (one for each eye) such that the displays immerse the user in the three-dimensional XR scene.

FIG. 13 is a flow diagram illustrating processes 1300, 1302, 1304, and 1306 used in some implementations for issuing software calls to multiple processor types using a host renderer to render encoded XR scene graph(s). In some implementations, instances of process 1300 can be performed by one or more content sources (e.g., XR applications) and process 1302 can be performed by a host renderer. In some implementations, process 1304 can be performed by first processor(s) and process 1306 can be performed by second processor(s). For example, a first device and a second device can comprise a XR system. The first device can comprise the first processor(s) and the second device can comprise the second processor(s). The XR applications and host renderer can execute at the first device, second device, or any other suitable device. In some implementations, where one or more of the XR applications and the host renderer execute at the same device, the XR application and host renderer can execute as part of the same software process or as part of different software processes.

At block 1308, process 1300 can generate XR scenes. For example, XR applications can generate XR scenes, each comprising a XR scene graph with multiple scene components. The scene components can include a skybox, background, virtual objects, etc. In some implementations, the scene components of each scene graph are renderable/drawable elements of the scene graphs. Each XR scene graph can store a relative location for scene components within the XR scenes, relationships/dependencies among the scene components, and other suitable XR scene information.

In some implementations, the XR applications can perform application functionality with respect to the scene components of the scene graphs. This application functionality can include: processing user input, performing physics simulations to simulate component interactions, gaming simulations, or any other suitable application functionality. In some implementations, the application functionality updates the state of scene components of the XR scene graphs and/or generates new scene components.

At block 1310, process 1300 can encode the XR scenes. For example, an encoder module can encode the XR applications' scene graphs into a format for the host renderer. Each encoded XR scene graph can include encoded scene components, or entities, and metadata for rendering the encoded scene components. In some implementations, for each encoded scene component/entity, a given encoded scene graph comprises or indicates one or more structures (e.g., mesh structures, sub-models, buffers, or other suitable structures) and one or more materials (e.g., materials, textures, shaders, etc.).

At block 1312, process 1300 can transmit the encoded scene graphs to the host renderer. For example, the XR applications (or a process that executes the XR applications) can transmit the encoded scene graph to the host renderer. At block 1314, process 1302 can receive the encoded scene graphs from the XR applications. For example, the host renderer can receive the encoded scene graphs from the XR applications.

At block 1316, process 1302 can decode the entities of the encoded scene graphs. For example, the host renderer can decode the entities comprised in each encoded scene graph and populate host primitives that represent the entities/components of the original XR scene graphs. For example, a given one of host primitives can comprise rendering information for rendering a given one of the scene components of the original XR scene graphs. In some implementations, the rendering information stored at the host primitives can include mesh structure(s), material(s), texture(s), buffer(s), shader(s), and any other suitable rendering information for rendering a component of a scene graph.

In some implementations, each entity of a given encoded scene graph can indicate encoded structure information and encoded material information. The encoded structure information can be one or more mesh structures (e.g., a model and one or more sub-models), or any other suitable structure information. The encoded material information can be materials for the one or more mesh structures (e.g., materials, textures, shaders, etc.), or any other suitable material information. In some implementations, the encoded entities comprise identifiers to persisted instances of meshes and/or materials stored at the host renderer. In some implementations, the encoded entities comprise the actual mesh information and/or material information. The host primitives can be generated by decoding the encoded structure information and encoded material information for each encoded scene component/entity.

At block 1318, process 1302 can generate processor render draw calls using the host primitives. For example, the host renderer can generate processor render calls using processor API(s) to render the scene components of the original XR scene graphs. The processor API(s) can target different processor types, such as CPUs, GPUs, mobile processors, or any other suitable processors. In some implementations, the entities and rendering information stored at the host primitives can be passed as a render list as part of the rendering calls. For example, the host primitives can comprise mesh information and/or material information, and the render draw calls can cause the one or more processors to render the scene components using the mesh information and material information.

The encoded scene graphs can include render metadata used to generate the processor render calls. For example, the render metadata can include one or more of: render commands, information used to generate the render commands, render call types (e.g., forward render, deferred render, ray tracer, etc.), render destination information, or any other suitable metadata for generating processor render calls. In some implementations, the host renderer generates a first set of processor calls of a first type to a first type of processor to render first ones of the encoded scene graphs and a second set of processor calls of a second type to a second type of processor to render second ones of the encoded scene graphs.

At block 1320, process 1302 can issue the first set of processor render draw calls to one or more first processor(s). For example, the first processor(s) can reside at a first device. The first device can be part of a multi-device XR system. In some implementations, the host renderer executes at the first device. At block 1322, process 1302 can issue the second set of processor render draw calls to one or more second processor(s). For example, the second processor(s) can reside at a second device. The second device can also be part of a multi-device XR system. In some implementations, the second set of processor render draw calls can be transmitted wirelessly to the second device.

At block 1324, process 1304 can perform the first set of processor render draw calls. For example, the one or more first processors can perform the first set of processor render draw calls at the first device. At block 1326, process 1304 can render first XR scenes via performance of the first set of processor render calls. For example, one or more first processors can be configured to draw pixels, in response to the first set of processor calls of the first type from the host renderer, that render the scene components of the first ones of the encoded scene graphs. The one or more first processors can be one or more graphics processor units (GPU), and the first set of processor calls of the first type can be executed by the one or more GPUs to draw pixels that render the scene components of the first ones of the encoded scene graphs.

At block 1328, process 1306 can perform the second set of processor render draw calls. For example, the one or more second processors can perform the second set of processor render draw calls at the second device. At block 1330, process 1306 can render second XR scenes via performance of the second set of processor render calls. For example, one or more second processors can be configured to draw pixels, in response to the second set of processor calls of the second type from the host renderer, that render the scene components of the second ones of the encoded scene graphs. The one or more second processors can be one or more mobile device CPU processors, and the second set of processor calls of the second type can be executed by the one or more mobile device CPU processors to draw pixels that render the scene components of the second ones of the encoded scene graphs.

In some implementations, the one or more first processors and one or more second processors execute rendering pipelines that render three-dimensional XR scenes comprising the rendered scene components. For example, three-dimensional XR scenes can be displayed to a user via an HMD of a XR system as two displays (one for each eye) such that the displays immerse the user in the three-dimensional XR scene.

FIG. 14 is a flow diagram illustrating processes 1400, 1402, and 1404 used in some implementations for dynamically rendering scene components from multiple encoded XR scene graphs using a host renderer. In some implementations, process 1400 can be performed by a first XR application, process 1402 can be performed by a second XR application, and process 1404 can be performed by a host renderer. The XR applications and host renderer can execute at a single device, or they can execute remote from one another. In some implementations, the first XR application can execute via a first software process, the second XR application can execute via second software process, and the host renderer can execute via a third software process. In some implementations, the first and second XR applications can execute via the same software process that is separate from the software process that executes the host renderer.

At block 1406, process 1400 can generate or update a local XR scene. For example, a first XR application can generate a XR scene comprising a first scene graph with multiple scene components. The scene components can include a skybox, background, virtual objects, etc. In some implementations, the scene components are renderable/drawable elements of the scene graph. The first scene graph can store a relative location for scene components within the XR scene, relationships/dependencies among the scene components, and other suitable XR scene information.

In some implementations, the first XR application can perform application functionality with respect to the scene components of the first scene graph. This application functionality can include: processing user input, performing physics simulations to simulate component interactions, gaming simulations, or any other suitable application functionality. In some implementations, the application functionality updates the state of scene components of the first scene graph and/or generates new scene components.

At block 1408, process 1400 can encode the first scene graph. For example, an encoder module can encode the first XR application's first scene graph into a format for the host renderer. The first encoded scene graph can include encoded scene components, or entities, and metadata for rendering the encoded scene components. In some implementations, for each encoded scene component/entity, the first encoded scene graph comprises or indicates one or more structures (e.g., mesh structures, sub-models, or other suitable structures) and one or more materials (e.g., materials, textures, shaders, etc.).

At block 1410, process 1400 can transmit the first encoded scene graph to the host renderer. For example, the first XR application and/or the software process that executes the first XR application can transmit the first encoded scene graph to the host renderer. In some implementations, the host renderer executes by a separate software process and the first encoded scene graph is transmitted to the host renderer via one or more inter-process communication messages.

At block 1412, process 1402 can generate or update a local XR scene. For example, a second XR application can generate a second XR scene comprising a second scene graph with multiple scene components. The scene components can include a skybox, background, virtual objects, etc. In some implementations, the scene components are renderable/drawable elements of the second scene graph. The second scene graph can store a relative location for scene components within the XR scene, relationships/dependencies among the scene components, and other suitable XR scene information.

In some implementations, the second XR application can perform application functionality with respect to the scene components of the second scene graph. This application functionality can include: processing user input, performing physics simulations to simulate component interactions, gaming simulations, or any other suitable application functionality. In some implementations, the application functionality updates the state of scene components of the second scene graph and/or generates new scene components.

At block 1414, process 1402 can encode the second scene graph. For example, an encoder module can encode the second XR application's second scene graph into a format for the host renderer. The second encoded scene graph can include encoded scene components, or entities, and metadata for rendering the encoded scene components. In some implementations, for each encoded scene component/entity, the second encoded scene graph comprises or indicates one or more structures (e.g., mesh structures, sub-models, or other suitable structures) and one or more materials (e.g., materials, textures, shaders, etc.)

At block 1416, process 1402 can transmit the encoded XR scene to the host renderer. For example, the second XR application and/or the software process that executes the second XR application can transmit the second encoded scene graph to the host renderer. In some implementations, the host renderer executes by a separate software process and the second encoded scene graph is transmitted to the host renderer via one or more inter-process communication messages.

At block 1418, process 1404 can receive the first and second encoded scene graphs from the first and second XR applications. For example, the host renderer can receive the first and second encoded scene graphs via inter-process communication messages from the first and second XR applications.

At block 1420, process 1404 can generate or update local encoded scenes using the received first and second encoded scene graphs. For example, the host renderer can store local versions of the first and second encoded scene graphs and update these location versions in response to inter-process communication messages from the first and second XR applications.

In some implementations, each of the first and second XR applications stores a local version of its encoded scene graph. For example, the first XR application can perform application functionality that updates the application's scene graph, and the local version of the first encoded scene graph maintained by the first XR application can be updated in response. The second XR application can also perform application functionality that updates the application's scene graph, and the local version of the second encoded scene graph maintained by the second XR application can be updated in response.

The inter-process communication messages from the first XR application can propagate updates from the local version of the first encoded scene graph managed at the first XR application to the local version of the first encoded scene graph managed at the host renderer. In addition, the inter-process communication messages from the second XR application can propagate updates from the local version of the second encoded scene graph managed at the second XR application to the local version of the second encoded scene graph managed at the host renderer.

In some implementations, the first XR application can push state updates for the first encoded scene graph at a first frequency rate. For example, the first frequency rate can be defined by: the first XR application, the host renderer, or any other suitable entity. The first frequency rate can control how often rendered components of the first encoded scene graph are updated (via new rendering calls). In some implementations, the second XR application can push state updates for the second encoded scene graph at a second frequency rate. For example, the second frequency rate can be defined by: the second XR application, the host renderer, or any other suitable entity. The second frequency rate can control how often rendered components of the second encoded scene graph are updated (via new rendering calls).

At block 1422, process 1404 can decode the entities of the encoded XR scene. For example, the host renderer can decode the entities comprised in the first encoded scene graph and populate host primitives that represent the entities/components of the first XR application's scene graph. For example, a given one of host primitives can comprise rendering information for rendering a given one of the scene components of the first XR application's scene graph. The host renderer can also decode the entities comprised in the second encoded scene graph and populate host primitives that represent the entities/components of the second XR application's scene graph. For example, a given one of host primitives can comprise rendering information for rendering a given one of the scene components of the second XR application's scene graph. In some implementations, the rendering information stored at the host primitives can include mesh structure(s), material(s), texture(s), buffer(s), shader(s), and any other suitable rendering information for rendering a component of the scene graphs.

In some implementations, each entity of the first and second encoded scene graphs can indicate encoded structure information and encoded material information. The encoded structure information can be one or more mesh structures (e.g., a model and one or more sub-models), or any other suitable structure information. The encoded material information can be materials for the one or more mesh structures (e.g., materials, textures, shaders, etc.), or any other suitable material information. In some implementations, the encoded entities comprise identifiers to persisted instances of meshes and/or materials stored at the host renderer. In some implementations, the encoded entities comprise the actual mesh information and/or material information. The host primitives can be generated by decoding the encoded structure information and encoded material information for each encoded scene component/entity.

At block 1424, process 1404 can generate processor render draw calls using the host primitives. For example, the host renderer can generate processor render calls using processor API(s) to jointly render the scene components of the first XR application's scene graph and the second XR application's scene graph. In some implementations, the entities and rendering information stored at the host primitives can be passed as a render list as part of the rendering calls. For example, the host primitives can comprise mesh information and/or material information, and the render draw calls can cause the one or more processors to render the scene components using the mesh information and material information.

The first and second encoded scenes can include render metadata used to generate the processor render calls. For example, the render metadata can include one or more of: render commands, information used to generate the render commands, render call types (e.g., forward render, deferred render, ray tracer, etc.), render destination information, or any other suitable metadata for generating processor render calls. In some implementations, the processor render calls can comprise a rendering pipeline.

At block 1426, process 1404 can issue the processor render draw calls to one or more processor(s) to jointly render the XR scenes from the first and second XR applications. For example, the host renderer can issue processor render draw calls to one or more processors that, in response to the draw calls, define pixels to jointly render the scene components from the first XR application's scene graph and the second XR application's scene graph. The one or more processors can include one or more CPUs, GPUs, multi-core processors, mobile processors, or any other suitable processors. In some implementations, the render draw calls comprise a rendering pipeline that cause the one or more processors to execute the rendering pipeline and render the scene components.

In some implementations, the first frequency rate (at which first encoded scene graph updates are transmitted from the first XR application to the host renderer) is faster than the second frequency rate (at which second encoded scene graph updates are transmitted from the second XR application to the host renderer). In this example, the rendered scene components of the first encoded scene graph are updated faster than the rendered scene components of second encoded scene graph. In other words, the rendered components from the first XR application's scene graph are updated faster than the rendered components from the second XR application's scene graph are updated.

In some implementations, the host renderer executes at a first device and at least a portion of the render draw calls are issued to a second device. For example, the first and second devices can comprise a XR system. In some implementations, the first device can be a companion processing component of the XR system, and the second device can be a HMD of the XR system. The one or more processors can comprise one or more mobile processors of the second device that execute the portion of the render draw calls.

In some implementations, the one or more processors execute the rendering pipeline and render a three-dimensional XR scene comprising the rendered scene components. For example, three-dimensional XR scene can be displayed to the user via an HMD of a XR system as two displays (one for each eye) such that the displays immerse the user in the three-dimensional XR scene.

FIG. 15 is a flow diagram illustrating processes 1500 and 1502 used in some implementations for dynamically rendering scene components from multiple artificial reality (XR) applications using a host bridge. In some implementations, process 1500 can be performed by a host bridge and process 1502 can be performed by a XR rendering engine. In some implementations, a first XR application can be an engine native XR application with respect to the XR rendering engine. On the other hand, a second XR application may not be native to the XR rendering engine. Implementations of the host bridge can convert content from the second XR application (e.g., non-native XR application) such that the converted content is renderable via the XR rendering engine.

In some implementations, a first device and a second device can comprise a XR system. The first device can comprise first processor(s) and the second device can comprise second processor(s). The XR applications, host bridge, and/or XR rendering engine can execute at the first device, second device, or any other suitable device. In some implementations, where one or more of the XR applications and the host bridge execute at the same device, the XR application and host bridge can execute as part of the same software process or as part of different software processes.

At block 1504, process 1500 can receive encoded scene components from XR application(s). For example, one or more XR applications (or processes that execute the XR applications) can transmit encoded scene components to the host bridge. In some implementations, an engine non-native XR application can provide the encoded scene components. An engine non-native XR application can generate a XR scene comprising a XR scene graph with multiple scene components. The scene components can include a skybox, background, virtual objects, lighting elements, etc. In some implementations, the scene components are renderable/drawable elements of the scene graph and/or elements that affect rendering. The XR scene graph can store a relative location for scene components within the XR scene, relationships/dependencies among the scene components, and other suitable XR scene information.

In some implementations, the engine non-native XR application can perform application functionality with respect to the scene components of the scene graph. This application functionality can include: processing user input, performing physics simulations to simulate component interactions, motion simulations, object interactions, or any other suitable application functionality. In some implementations, the application functionality updates the state of scene components of the XR scene graph and/or generates new scene components.

In some implementations, the engine non-native XR application can encode the XR scene graph. For example, an encoder module can encode the engine non-native XR application's scene graph into a format for the host bridge. The encoded XR scene graph can include encoded scene components, or entities, and metadata for rendering the encoded scene components. In some implementations, for each encoded scene component/entity, the encoded scene graph comprises or indicates one or more structures (e.g., mesh structures, sub-models, or other suitable structures) and one or more materials (e.g., materials, textures, shaders, etc.).

In some implementations, engine native scene components can be received at the host bridge. For example, engine native rendering content can be content generated by an engine native XR application and content formatted according to primitives and/or metadata structures native to the XR rendering engine. The engine native rendering content can comprise engine native primitives that store structure information (e.g., mesh(es)) and material information (e.g., material(s), texture(s), etc.) for renderable components, and rendering metadata that defines rendering information (e.g., type of draw call, render location, etc.).

At block 1506, process 1500 can decode entities of the encoded scene components. For example, the host bridge can decode the entities comprised in the encoded scene components and populate host primitives that represent the entities/components of the original XR scene graph(s) from the XR application(s). For example, a given one of the host primitives can comprise rendering information for rendering a given one of the scene components. In some implementations, the rendering information stored at the host primitives can include mesh structure(s), material(s), texture(s), buffer(s), shader(s), and any other suitable rendering information for rendering a component of a scene graph.

In some implementations, each entity of the encoded scene graph can indicate encoded structure information and encoded material information. The encoded structure information can be one or more mesh structures (e.g., a model and one or more sub-models), or any other suitable structure information. The encoded material information can be materials for the one or more mesh structures (e.g., materials, textures, shaders, etc.), or any other suitable material information. In some implementations, the encoded entities comprise identifiers to persisted instances of meshes and/or materials stored at the host bridge. In some implementations, the encoded entities comprise the actual mesh information and/or material information. The host primitives can be generated by decoding the encoded structure information and encoded material information for each encoded scene component/entity.

At block 1508, process 1500 can generate engine compatible rendering information using the decoded scene components. For example, the engine compatible rendering information can be a) one or more engine compatible primitives converted from the one or more host bridge primitives, and/or b) one or more hardware level application programming interface calls generated using the one or more host bridge primitives.

In some implementations, one or more engine compatible primitives are converted from the one or more host bridge primitives. For example, the XR rendering engine may be incompatible with the structure of the host bridge's primitives. In order to provide the XR rendering engine with data renderable by the engine, the host bridge can convert the host primitives to XR rendering engine primitives. Because the converted XR rendering engine primitives are created using the host primitives populated via the decoded scene components, the converted engine primitives can represent the scene components received at the host bridge.

In some implementations, one or more hardware level application programming interface calls are generated using the one or more host bridge primitives. For example, the one or more hardware level application programming interface calls can render into a render target at the XR rendering engine. The render target can be an engine compatible material and/or texture that can be applied to model(s) to render scene component content.

At block 1510, process 1500 can transmit the engine compatible rendering information to the XR rendering engine. For example, the host bridge can transmit/issue the engine compatible rendering information (e.g., converted engine primitives and/or hardware level application programming interface calls) to the XR rendering engine. At block 1512, process 1502 can receive the engine compatible rendering information from the host bridge.

At block 1514, process 1502 can generate processor render calls for one or more processor(s). For example, using the engine compatible rendering information, the XR engine can generate processor render calls (e.g., a rendering pipeline). In some implementations, the engine compatible rendering information comprises converted engine primitives. The converted engine primitives can: contain the decoded information from scene components; and comprise a formatting compatible with rendering via the XR rendering engine. The XR rendering engine can then generate rendering calls (e.g., a rendering pipeline) using the converted engine primitive(s) such that the render calls, when executed, render the scene component(s)

In some implementations, the engine compatible rendering information comprises application programming interface calls that render into a render target. The XR rendering engine can generate the render draw calls such that the render target is applied to model information from one or more engine compatible primitives. In some implementations, when one or more processors execute the render calls, applying the engine compatible material to the model information from the one or more engine compatible primitives renders scene component(s).

In some implementations, using engine native content from the engine native XR application, the XR rendering engine can generate first processor rendering calls (e.g., a rendering pipeline) for one or more processors. Using the engine compatible rendering information (e.g., converted engine primitives and/or render target of the application programming interfaces calls from the host bridge), the XR rendering engine can generate second processor rendering calls for the one or more processors. In some implementations, the XR rendering engine can combine the first processor rendering calls and the second processor rendering calls to generate a combined rendering pipeline.

At block 1516, process 1502 can issue the processor render calls to the one or more processor(s). The one or more processors, in response to the render draw calls, can render the scene component(s) originated by the XR application(s) that provided encoded scene components to the host bridge. For example, the render draw calls issued by the XR rendering engine comprise one or more rendering pipelines that cause the one or more processors to execute the one or more rendering pipelines and jointly render the scene components.

In some implementations, the XR rendering engine receives, from the engine native XR application and/or the host bridge, one or more engine compatible primitives that store information for a native scene component (e.g., scene component originated at the engine native XR application). The XR rendering engine can issue the processor render calls to the one or more processors that can, in response to the processor render calls, jointly render the content from multiple XR application (e.g., the non-native XR application and the engine native XR application). For example, the XR rendering engine can issue the combined processor render calls such that the one or more processors execute the combined rendering pipeline to jointly render the content.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for dynamically rendering scene components from multiple encoded artificial reality (XR) scene graphs using a host renderer, the method comprising,
receiving, at the host renderer, a first encoded XR scene graph from a first XR application and a second encoded XR scene graph from a second XR application, wherein:
the first XR application encodes a first XR application scene graph comprising first scene components to generate the first encoded XR scene graph,
the second XR application encodes a second XR application scene graph comprising second scene components to generate the second encoded XR scene graph,
the first scene components comprise renderable elements of the first XR application scene graph and the second scene components comprise renderable elements of the second XR application scene graph, and
the first encoded XR scene graph comprises first render metadata and the second encoded XR scene graph comprises second render metadata;
decoding, at the host renderer, the first encoded XR scene graph and the second encoded XR scene graph; and
issuing, using A) the decoded first XR scene graph, B) decoded second XR scene graph, C) first render metadata, and D) second render metadata, render draw calls to one or more processors that, in response to the render draw calls, jointly render the first XR application scene graph comprising the first scene components and the second XR application scene graph comprising the second scene components.

2. The method of claim 1, wherein the render draw calls comprise one or more rendering pipelines that cause the one or more processors to execute the one or more rendering pipelines and jointly render the first XR application scene graph comprising the first scene components and the second XR application scene graph comprising the second scene components.

3. The method of claim 1, wherein the host renderer is executed via a first software process, and the first XR application and second XR application are executed via one or more additional software processes that are separate from the first software process.

4. The method of claim 3, wherein the host renderer and first software process are executed at a XR system, and the first XR application and/or second XR application are executed remote from the XR system.

5. The method of claim 3, wherein the first encoded XR scene graph from the first XR application and the second encoded XR scene graph from the second XR application are received via inter-process protocol communication messages.

6. The method of claim 5, wherein,
the first XR application manages a version of the first encoded XR scene graph local to the first XR application,
the second XR application manages a version of the second encoded XR scene graph local to the second XR application, and
the host renderer manages versions of the first encoded XR scene graph and the second encoded XR scene graph local to the host renderer.

7. The method of claim 6, wherein,
one or more first inter-process protocol communication messages comprise updates to the first encoded XR scene graph from the first XR application,
one or more second inter-process protocol communication messages comprise updates to the second encoded XR scene graph from the second XR application, and
the host renderer updates its local versions of the first encoded XR scene graph and the second encoded XR scene graph using the one or more first inter-process protocol communication messages and the one or more second inter-process protocol communication messages.

8. The method of claim 7, wherein the one or more first inter-process communication protocol messages are received at a first frequency rate and the one or more second inter-process communication protocol messages are received at a second frequency rate, and the first frequency rate is faster than the second frequency rate.

9. The method of claim 8, wherein the render draw calls to the one or more processors cause the processors to render updates of the first scene components at a faster rate than updates of the second scene components.

10. The method of claim 1, wherein the first encoded XR scene graph is different from the second encoded XR scene graph.

11. A computer-readable storage medium storing instructions that, when executed by a computing system, cause the computing system to perform a process for dynamically rendering scene components from multiple encoded artificial reality (XR) scene graphs using a host renderer, the process comprising:
receiving a first encoded XR scene graph and a second encoded XR scene graph, wherein:
a first XR application encodes a first scene graph comprising first scene components to generate the first encoded XR scene graph,
a second XR application encodes a second scene graph comprising second scene components to generate the second encoded XR scene graph, and
the first encoded XR scene graph comprises first render metadata and the second encoded XR scene graph comprises second render metadata;
decoding the first and second encoded XR scene graphs; and
issuing, using the decoded first and second XR scene graphs and the first and second render metadata, render draw calls to one or more processors that, in response to the render draw calls, jointly render the first scene graph comprising the first scene components and the second scene graph comprising the second scene components.

12. The computer-readable storage medium of claim 11, wherein the render draw calls comprise one or more rendering pipelines that cause the one or more processors to execute the one or more rendering pipelines and jointly render the first scene graph comprising the first scene components and the second scene graph comprising the second scene components.

13. The computer-readable storage medium of claim 11, wherein the host renderer is executed via a first software process, and the first XR application and second XR application are executed via one or more additional software processes that are separate from the first software process.

14. The computer-readable storage medium of claim 13, wherein the host renderer and first software process are executed at a XR system, and the first XR application and/or second XR application are executed remote from the XR system.

15. The computer-readable storage medium of claim 13, wherein the first encoded XR scene graph and the second encoded XR scene graph are received via inter-process protocol communication messages.

16. The computer-readable storage medium of claim 15, wherein,
the first XR application manages a version of the first encoded XR scene graph local to the first XR application,
the second XR application manages a version of the second encoded XR scene graph local to the second XR application, and
the host renderer manages versions of the first encoded XR scene graph and the second encoded XR scene graph local to the host renderer.

17. The computer-readable storage medium of claim 16, wherein,
one or more first inter-process protocol communication messages comprise updates to the first encoded XR scene graph from the first XR application,
one or more second inter-process protocol communication messages comprise updates to the second encoded XR scene graph from the second XR application, and
the host renderer updates its local versions of the first encoded XR scene graph and the second encoded XR scene graph using the one or more first inter-process protocol messages and the one or more second inter-process protocol messages.

18. The computer-readable storage medium of claim 17, wherein the one or more first inter-process protocol messages are received at a first frequency rate and the one or more second inter-process protocol messages are received at a second frequency rate, and the first frequency rate is faster than the second frequency rate.

19. The computer-readable storage medium of claim 18, wherein the render draw calls to the one or more processors cause the processors to render updates of the first scene components at a faster rate than updates of the second scene components.

20. A computing system for dynamically rendering scene components from multiple encoded artificial reality (XR) scene graphs using a host renderer, the computing system comprising:
one or more processors; and
one or more memories storing instructions that, when executed by the one or more processors, cause the computing system to perform a process comprising:
receiving a first encoded XR scene graph and a second encoded XR scene graph, wherein:
a first XR application encodes a first scene graph comprising first scene components to generate the first encoded XR scene graph,
a second XR application encodes a second scene graph comprising second scene components to generate the second encoded XR scene graph, and
the first encoded XR scene graph comprises first render metadata and the second encoded XR scene graph comprises second render metadata;
decoding the first and second encoded XR scene graphs; and
issuing, using the decoded first and second XR scene graphs and the first and second render metadata, render draw calls to one or more processors that, in response to the render draw calls, jointly render the first scene graph comprising the first scene components and the second scene graph comprising the second scene components.
the native scene component is originated by a native XR application,
the render draw calls to the one or more processors are issued by the XR rendering engine using the engine compatible rendering information and the one or more other engine compatible primitives, and
in response to the render draw calls, the one or more processors jointly render the scene component and native scene component.
